(19) United States
(12) Patent Application Publication
(10) Pub. No.: US 2010/0210461 A1
(43) Pub. Date: Aug. 19, 2010

(54) Compositions comprising alcohol alkoxylates, and use of the alcohol alkoxylates as adjuvant for the agrochemical sector

(75) Inventors: Michael Stoesser, Neuhofen (DE); Rainer Berghaus, Speyer (DE); Gerhard Krennrich, Frankenthal (DE); Markus Kummeter, Heddesheim (DE); Guenter Oetter, Frankenthal (DE); Jurith Montag, Limburgerhof (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/669,215

(22) PCT Filed: Jul. 18, 2008
(86) PCT No.: PCT/EP2008/059476

§ 371 Date: Jan. 15, 2010

(30) Foreign Application Priority Data
Jul. 20, 2007 (EP) 07112894.6

(51) Int. Cl. A01N 63/00

(52) U.S. Cl. 504/118

(57) ABSTRACT

The present invention relates to agrochemical compositions which comprise certain alcohol alkoxylates of the amphiphilic type, and the use of the alcohol alkoxylates as activity-improving adjuvant in the agrochemical sector, and in particular in the plant protection sector. The alcohol alkoxylates take the form of alkoxylated alcohols of the formula (I)

R—O—[(CₙH₂ₙO)ₓ-(PhC₂H₃O)_{y}—(CₘH₂ₘO)_{z}]_{co}—H (I)

in which
R represents a hydrocarbon radical having 1 to 30 carbon atoms;
n, m independently of one another represent a value of from 2 to 16;
x represents a value of from 0 to 100;
y represents a value of from 0.5 to 100;
z represents a value of from 0 to 100; and
x+y+z corresponds to a value of from 2 to 100,
where at least one of x or z is greater than 0.

The present invention relates to agrochemical compositions which comprise certain alcohol alkoxylates of the amphiphilic type, and the use of the alcohol alkoxylates as activity-improving adjuvant in the agrochemical sector, and in particular in the plant protection sector.

Besides the optimization of the active ingredient properties, the development of an effective agent is of particular importance with regard to the industrial production and application of active ingredients. By formulating the active ingredient(s) correctly, an optimal balance must be found between properties, some of which are in conflict with each other, such as the biological activity, the toxicology, potential environmental effects, and the costs. Moreover, the formulation is a decisive factor in determining the shelf life and the user friendliness of a composition.

An efficient uptake of the active ingredient by the plant is of particular importance for the activity of an agrochemical composition. If this uptake is via the leaf, it constitutes a complex translocation process, where the active substance, for example a herbicide, must first penetrate the waxy cuticula of the leaf and subsequently diffuse, via the cuticula, into the tissue underneath, to the actual site of action.

It is generally known and agricultural practice to add certain adjuvants to formulations in order to improve the activity of the latter. Advantageously, this allows the amounts of active ingredient in the formulation to be reduced while maintaining the same activity, thereby being able to minimize costs and, if appropriate, operating within existing legislation. In individual cases, this also allows the spectrum of the active ingredient to be widened, since plants whose treatment with a specific active ingredient without addition was only possible to an unsatisfactory extent, are now capable of being subjected to such a treatment as the result of the addition of certain auxiliaries. Furthermore, the performance under adverse environmental conditions may be increased in individual cases by a suitable formulation. Of course, incompatibilities of various active ingredients in one formulation can also be avoided.

Such auxiliaries are sometimes also referred to adjuvants. Frequently, they take the form of surface-active or salt-like compounds. Depending on their mode of action, one can distinguish between, for example, modifiers, actuators, fertilizers and pH buffers. Modifiers influence the wetting, adhesion and spreading of a formulation. Actuators break the waxy plant cuticula and improve the penetration of the active ingredient into the cuticula, both in the short term (within minutes) and in the long term (within hours). Fertilizers such as ammonium sulfate, ammonium nitrate or urea improve the absorption and solubility of the active ingredient, and they may reduce antagonistic patterns of behavior of active ingredients. pH buffers are traditionally used for optimally adjusting the pH of the formulation.

As regards the uptake of the active ingredient into the leaf, surface-active substances may act as modifiers and actuators. In general, it is assumed that suitable surface-active substances are capable of increasing the effective contact area of fluids on leaves by reducing the surface tension. Moreover, certain surface-active substances are capable of dissolving or disrupting the epicuticular waxes, which facilitates the absorption of the active ingredient. Furthermore, some surface-active substances are also capable of improving the solubility of active ingredients in formulations, thereby avoiding, or at least delaying, crystal formation. Finally, in certain cases they can also influence the absorption of active ingredients by retaining moisture.

Adjuvants of the surface-active type are exploited in many ways for agrochemical purposes. They can be divided into anionic, cationic, nonionic or amphoteric groups of substances.

Petrol-based oils have traditionally been used as activating adjuvants. In recent times, seed extracts, natural oils and their derivatives, for example, from soybeans, sunflowers and coconut, have also been employed.

The synthetic surface-active substances which have usually been used as actuators take the form of, inter alia, polyoxyethylene condensates with alcohols, alkylphenols or alkylamines with HLB values in the range of from 8 to 13. In this regard, the document WO 00/42847 mentions for example the use of certain linear alcohol alkoxylates in order to increase the activity of agrochemical biocide formulations. WO 03/090531 describes the use of alkoxylates of certain branched alcohols, among which in particular 2-propylheptanol, C13-oxoalcohols and C10-oxoalcohols, as adjuvant for the agrochemical sector. Similar alcohol alkoxylates have been proposed in WO 2005/015998 specifically as adjuvants for fungicidal benzamide oxime derivatives. WO 00/35278 relates to agrochemical formulations based on PO/EO block copolymers of 2-ethylhexanol.

However, the spectrum of alcohol alkoxylates is varied. As surfactants, they are predominantly used in detergents and cleaners, in the metal-working industry, in the production and processing of textiles, in the leather industry, in papermaking, in the printing, electroplating and photographic industries, in water treatment, in pharmaceutical, veterinary and plant protection formulations, or in the plastics manufacturing and processing industries.

EP-A 1 078 946 describes block copolymeric, styrene-oxide-containing polyalkylene oxides of straight-chain or branched or cycloaliphatic alcohols having 8 to 13 carbon atoms and their use as low-foam pigment wetters in aqueous pigment pastes, aqueous and low-solvent varnishes and inks. Similar styrene-oxide-containing block copolymers are described in EP-A 1 403 324 as viscosity regulators in thickeners for paints and varnishes. The same block copolymeric, styrene-oxide-containing polyalkylene oxides are proposed in accordance with WO-A 2006/097378 in combination with ketone/aldehyde resins as dispersants, both for solvent-free, solvent-containing and aqueous universal pigment preparations (see also WO-A 2006/097379).

Further styrene-oxide-containing copolymers and their use as emulsifiers and dispersants in the field of the pigment and bitumen dispersions and in emulsion polymerization are described in DE-A 102 52 452.

EP-A 403 718 relates to styrene-oxide-containing polyalkylene oxides of alcohols having 1 to 24 carbon atoms and to their use as textile-finishing agents, in particular as emulsifiers, dyeing adjuvants, wetters, deaerators or padding agents.

JP-A 03206001 describes styrene oxide adducts of polyethylene glycols and polypropylene glycols with weight-average molecular weights of 20000 g/mol and more and their use as emulsifiers in insecticide-containing aqueous emulsions. WO-A 2006/002984 proposes to employ nonionic block copolymers in liquid concentrates of pesticides as emulsifiers. The nonionic block copolymers essentially take the form of EO/PO tri-block copolymers. This publication furthermore mentions block copolymers of the formulae R¹-PEO-O-PAO-R² or R¹-PAO-O-PEO-H, where R¹ is C₁-C₂₀-alkyl or C₁-C₂₀-alkylphenyl, R² is hydrogen, C₁-C₈-alkyl, C₁-C₈-alkylcarbonyl or benzyl, PEO is a polyethylene oxide unit, and PAO is a hydrophobic polyether unit derived from C₁-C₁₀-alkylene oxides such as propylene oxide, 1,2-butylene oxide, cis- or trans-2,3-butylene oxide or isobutylene oxide, 1,2-pentene oxide; 1,2-hexene oxide, 1,2-decene oxide or styrene oxide, preferably from C₃-C₄-alkylene oxides.

It is in particular the structures of the alcohol moiety and in certain cases also those of the alkoxylate moiety which influence the properties of the alkoxylates so that a variety of technical effects come in useful in the abovementioned applications. These include wetting, spreading, penetration, adhesion, film formation, the improvement of compatibilities, drift control, and defoaming.

The present invention is based on the object of providing further adjuvants which are useful in the agrochemical sector.

This object is achieved by the present invention by the use of styrene-oxide-containing alcohol alkoxylates as adjuvant and by the provision of agrochemical compositions which comprise these alkoxylates.

The present invention therefore relates to compositions comprising

(a) at least one active ingredient for treating plants; and
(b) at least one alkoxylated alcohol of the formula (I)

R—O—(CₚH₂ₚO)_{q}-[(CₙH₂ₙO)ₓ—(PhC₂H₃O)_{y}—(CₘH₂ₘO)_{z}]_{co}-Z (I)

in which
R represents an aliphatic or aromatic radical having 1 to 30 carbon atoms;
p represents 2 or 3;
q represents 0, 1, 2 or 3;
n, m independently of one another represent an integer from 2 to 16;
x represents a value of from 0 to 100;
y represents a value of from 0.5 to 100;
z represents a value of from 0 to 100;
x+y+z corresponds to a value of from 2 to 100, and
Z represents hydrogen or an end cap,
where at least one of x or z is greater than 0.

The alcohol alkoxylates which are present in the compositions according to the invention have adjuvant, in particular activity-enhancing, properties. Thus, the addition of such alkoxylates makes possible a faster uptake of active ingredients by a plant to be treated with the active ingredient. The adjuvant activity gives rise in particular to the following aspects in the treatment of plants with one or more active ingredients:
a comparatively greater activity of the active ingredient at a given application rate;
a comparatively lower application rate at a given activity;
a comparatively greater uptake of the active ingredient by the plant, in particular via the leaf, and therefore advantages in the post-emergence method, in particular in the spray treatment of plants.

Accordingly, the present invention also relates to the use of an alkoxylated alcohol of the formula (I)

R—O—(CₚH₂ₚO)_{q}-[(CₙH₂ₙO)ₓ—(PhC₂H₃O)_{y}—(CₘH₂ₘO)_{z}]_{co}-Z (I)

in which
R represents an aliphatic or aromatic radical having 1 to 30 carbon atoms;
p represents 2 or 3;
q represents 0, 1, 2 or 3;
n, m independently of one another represent an integer from 2 to 16;
x represents a value of from 0 to 100;
y represents a value of from 0.5 to 100;
z represents a value of from 0 to 100;
x+y+z corresponds to a value of from 2 to 100, and
Z represents hydrogen or an end cap,
where at least one of x or z is greater than 0
as adjuvant in the treatment of plants.

The use according to the invention is directed in particular to plant cultivation, to agriculture and to horticulture. In particular, it serves for controlling undesired plant growth.

Accordingly, the present invention also relates to methods corresponding to the above purposes for the treatment of plants, where a suitable amount of alkoxylate according to the invention is applied.

Special advantages are obtained in particular in the cultivation of Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica aleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Ribes sylvestre, Ricinus communis, Saccharum officinarum, Secale cereale, Sinapsis alba, Solanum tuberosum, Sorghum bicolor (s. vulgare), Theobroma cacao, Trifolium pratense, Triticale, Triticum aestivum, Triticum durum, Vicia faba, Vitis vinifera, Zea mays.

Special effects are obtained by the compositions according to the invention in the cultivation of Allium cepa, Hordeum vulgare, Triticum aestivum and Triticum durum.

Moreover, the alkoxylates to be used in accordance with the invention can also be used in crops which tolerate the action of pesticides, in particular of herbicides. Such crops can be obtained for example by breeding, but also by recombinant methods.

Some of the alkoxylates according to the invention are known per se. For example, the publications EP-A 1 078 946, EP-A 1 403 324, WO-A 2006097378, WO-A 2006097379, DE-A 102 52 452 and EP-A 403 718 which have been mentioned at the outset describe suitable alkoxylates. The description of these alkoxylates in these publications is herewith expressly referred to, and the alkoxylates themselves, and also their preparation, disclosed therein are thereby incorporated into the present disclosure by reference.

The alcohol moiety of the alcohol alkoxylates to be used in accordance with the invention is, as a rule, based on alcohols or alcohol mixtures having 1 to 30 carbon atoms, which alcohols or alcohol mixtures are known per se. They include firstly short-chain alcohols or alcohol mixtures having 1 to 7 and in particular either 1 to 4 or 5 to 7 carbon atoms, and secondly long-chain alcohols or alcohol mixtures having 8 to 30, preferably 8 to 20, and in particular 9 to 15 carbon atoms. They are expediently monofunctional alcohols.

In formula (I), R represents the aliphatic or aromatic radical of an alcohol R—OH which may be employed as starter alcohol in the preparation of the alcohol alkoxylates. R preferably represents C₁-C₃₀-alkyl or C₁-C₃₀-alkenyl.

In the event that the alcohol is a short-chain aliphatic alcohol, R in formula (I) represents in particular short-chain alkyl, such as methyl, ethyl, n-propyl, isopropyl, n-butyl, 2-butyl, isobutyl or tert-butyl, n-pentyl, 1-methylbutyl, 2-methylbutyl, 3-methyl-butyl, 1,1-dimethylpropyl, 1,2-dimethylpropyl, 2,2-dimethylpropyl, 1-ethylpropyl, 2-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethyl-butyl, 3,3-dimethylbutyl, 1-ethylbutyl, 2-ethylbutyl, 3-ethylbutyl, 1,1,2-trimethylpropyl, 1,2,2-trimethylpropyl, 1-ethyl-1-methylpropyl, 1-ethyl-2-methylpropyl, 2-ethyl-1-methyl-propyl, 2-ethyl-2-methylpropyl, n-heptyl, 1-methylhexyl, 2-methylhexyl, 3-methylhexyl, 4-methylhexyl, 5-methylhexyl, 1,1-dimethylpentyl, 1,2-dimethylpentyl, 1,3-dimethyl-pentyl, 1,4-dimethylpentyl, 2,2-dimethylpentyl, 2,3-dimethylpentyl, 2,4-dimethylpentyl, 3,3-dimethylpentyl, 3,4-dimethylpentyl, 4,4-dimethylpentyl, 1-ethylpentyl, 2-ethylpentyl, 3-ethylpentyl, 4-ethylpentyl, 1,1,2-trimethylbutyl, 1,1,3-trimethylbutyl, 1,2,2-trimethyl-butyl, 1,2,3-trimethylbutyl, 1,3,3-trimethylbutyl, 1-ethyl-1-methylbutyl, 1-ethyl-2-methyl-butyl, 1-ethyl-3-methylbutyl, 2-ethyl-1-methylbutyl, 2-ethyl-2-methylbutyl, 2-ethyl-3-methylbutyl, 3-ethyl-1-methylbutyl, 3-ethyl-2-methylbutyl, 3-ethyl-3-methyl-butyl, 1-propylbutyl, 2-propylbutyl, 3-propylbutyl, 1-butylpropyl, 2-butylpropyl, 1-propyl-1-methylpropyl, 1-propyl-2-methylpropyl, 2-propyl-1-methylpropyl, 2-propyl-2-methylpropyl, 1,1-diethylpropyl, 1,2-diethylpropyl or 2,1-diethylpropyl, it also being possible for mixtures of two or more alcohol alkoxylates in which R is different to be suitable.

In the event that the alcohol is a long-chain aliphatic alcohol, R in formula (I) represents in particular long-chain alkyl such as octanyl, 2-ethylhexanyl, nonanyl, decanyl, undecanyl, dodecanyl, 2-butyloctanyl, tridecanyl, tetradecanyl, pentadecanyl, isooctanyl, isononanyl, isodecanyl, iso-undecanyl, isododecanyl, isotridecanyl, isotetradecanyl, isopentadecanyl, 2-propylheptanyl, hexadecanyl, heptadecanyl, octadecanyl, it also being possible for mixtures of two or more alcohol alkoxylates in which R is different to be suitable.

In the event that the alcohol is a cycloaliphatic or aromatic alcohol, R in formula (I) represents in particular cyclohexanyl, phenyl, cresyl isomers, isobutylphenyl, isobutylcresyl, diisobutylphenyl, diisobutylcresyl, tert-butylphenyl, tert-butylcresyl, di-tert-butylphenyl, di-tert-butylcresyl, isooctylphenyl, diisooctylphenyl, isononylphenyl, diisononylphenyl, isododecylphenyl, diisododecylphenyl, naphthyl, anthracenyl, it also being possible for mixtures of two or more alcohol alkoxylates in which the R is different to be suitable.

The alcohol moiety of the alkoxylates to be used may be straight-chain (linear), branched or cyclic. In the event that it is branched, the main chain of the alcohol moiety, according to a particular embodiment, has, as a rule, 1 to 4 branches, it also being possible to use alcohols with a higher or lower degree of branching in admixture with other alcohol alkoxylates, as long as the mean number of branches in the mixture is within the stated range.

In general, the branches independently of one another have 1 to 10, preferably 1 to 6 and in particular 1 to 4 carbon atoms. Particular branches are methyl, ethyl, n-propyl or isopropyl groups.

The linear short-chain alcohols include in particular methanol, ethanol, n-propanol, n-butanol, n-pentanol and n-hexanol, furthermore n-heptanol.

The linear long-chain alcohols include, in particular, octadecanol (stearyl alcohol). Among the branched long-chain alcohols, 2-ethylhexanol and 2-propylheptanol must be mentioned in particular. In addition, isodecanol and isotridecanol are of importance.

The abovementioned alcohols having 8 or 10 carbon atoms, in particular the branched ones, such as isodecanol and Isotridecanol having a degree of branching in the range from 1 to 4, are particularly advantageous.

In accordance with a particular embodiment, the alkoxylated alcohol is selected among alkoxylated alcohols of the formula (I) where q represents zero.

In accordance with a particular embodiment, the alkoxylated alcohol is selected among alkoxylated alcohols of the formula (I) where q represents 1, 2 or 3. Such alcohol alkoxylates can be prepared in a targeted fashion by reacting for example a compound of the formula (III)

R—O—(CₚH₂ₚO)_{q}—H (III)

where
R, p and q are as defined herein first with styrene oxide and alkylene oxide.

The compounds of the formula (III) are, in particular, mono-C₁-C₇-alkyl ethers of ethylene glycol (p=2; q=1), propylene glycol (p=3; q=1), diethylene glycol (p=2; q=2), dipropylene glycol (p=3; q=2), triethylene glycol (p=2; q=3) or tripropylene glycol (p=3; q=3), which are known per se.

Of particular importance in accordance with in the invention are the alkyl ethers of mono-, di- and tripropylene glycol of the formula (IIIa)

R—O—(CH₂CH(CH₃)O)_{q}—H (IIIa)

where R represents C₁-C₇-alkyl and q is as defined herein.

Another aspect emphasizes the mono-C₁-C₄-alkyl ethers (i.e. R represents in particular C₁-C₄-alkyl), and of these especially the dipropylene glycol monoalkyl ethers (q=2). They include, in particular, dipropylene glycol monomethyl ether, dipropylene glycol monoethyl ether, dipropylene glycol mono-n-propyl ether and dipropylene glycol mono-n-butyl ether.

Suitable alcohols and in particular fatty alcohols are obtainable not only from native sources, for example by obtaining and, if required or desired, by hydrolyzing, transesterifying and/or hydrogenating, glycerides and fatty acids, but also via the synthetic route, for example synthesis from starting materials with a lower number of carbon atoms. Thus, for example the SHOP process (Shell Higher Olefin Process) gives, starting from ethene, olefin fractions with a carbon number which is suitable for processing into surfactants. The functionalization of the olefins to give the corresponding alcohols is performed here for example by hydroformylation and hydrogenation.

Olefins with a carbon number suitable for processing into suitable alcohols can also be obtained by oligomerizing C₃-C₆-alkenes such as, in particular, propene or butene, or mixtures of these.

Lower olefins can furthermore be oligomerized by means of heterogeneous acidic catalysts, for example supported phosphoric acid, and subsequently functionalized to give alcohols.

A general possibility for the synthesis of branched alcohols is, for example, the reaction of aldehydes or ketones with Grignard reagents (Grignard synthesis). It is also possible to employ, instead of Grignard reagents, aryl-lithium compounds or alkyl-lithium compounds, which are distinguished by a higher reactivity. Furthermore, the branched alcohols can be obtained by aldol condensation, the reaction conditions being known to the skilled worker.

The alkoxylation is the result of the reaction with styrene oxide and suitable alkylene oxides which, as a result, have 2 to 16 and preferably 2 to 6 carbon atoms. The following may be mentioned in particular in this context: ethylene oxide (EO), 1,2-propylene oxide (PO), 1,2-butylene oxide (BO), 1,2-pentylene oxide (PeO) and 1,2-hexylene oxide (HO). Furthermore, decylene oxide (DeO) must also be mentioned. Particularly preferred are ethylene oxide (EO) and 1,2-propylene oxide (PO). Accordingly, alcohol alkoxylates of the formula (I) or specific embodiments thereof in which n and m independently of one another represent 2 or 3, for example n represents 2 and m represents 3, n represents 3 and m represents 2, or n and m represent 2, must be mentioned in particular in accordance with the invention.

The respective degree of alkoxylation is the result of the charged amounts of alkylene oxide(s) and the reaction conditions selected for the reaction. The former is, as a rule, a statistical mean, since the number of styrene oxide and alkylene oxide units of the alcohol alkoxylates which are the result of the reaction varies.

The degree of alkoxylation, i.e. the mean chain length of the polyether chains of alcohol alkoxylates according to the invention and their composition (in other words, the values of x, y, z) can be controlled by the ratio of the molar amounts of alcohol to styrene oxide and alkylene oxide employed in their preparation, and by the reaction conditions. Preferred alcohol alkoxylates are those which have at least approximately 2, preferably at least approximately 4, in particular at least approximately 5, especially at least approximately 6, 7 or 8 and particularly preferably at least approximately 10 styrene oxide and alkylene oxide units (x+y+z). In accordance with a further aspect, alcohol alkoxylates having up to about 100, preferably having up to about 80, in particular having up to about 60, especially having up to about 40 and particularly preferably having up to about 30 styrene oxide and alkylene oxide units (x+y+z) may be mentioned. If x=zero, alcohol alkoxylates having at least approximately 2, preferably at least approximately 4, in particular at least approximately 5, especially at least approximately 6, 7 or 8 and particularly preferably having at least approximately 10 styrene oxide and alkylene oxide units (y+z) are preferred, and in accordance with a further aspect the alcohol alkoxylates have up to about 100, preferably up to about 80, in particular up to about 60, especially up to about 40 and particularly preferably up to about 30 styrene oxide and alkylene oxide units (y+z). If z=zero, alcohol alkoxylates having at least approximately 2, preferably at least approximately 4, in particular at least approximately 5, especially at least approximately 6, 7 or 8 and particularly preferably having at least approximately 10 styrene oxide and alkylene oxide units (y+x) are preferred, and in accordance with a further aspect the alcohol alkoxylates have up to about 100, preferably up to about 80, in particular up to about 60, especially up to about 40 and particularly preferably up to about 30 styrene oxide and alkylene oxide units (y+x). Thus, the degree f alkoxylation (sum of x, y and z, of y and z, or of x and y) is preferably in the range from about 2 to 100, about 4 to 80, about 5 to 60, about 6, 7 or 8 to 40, or about 10 to 30.

In accordance with a particular embodiment, the alcohol alkoxylates of the formula (I) used are those in which the value of x, the value of z or the total of x and z is greater than the value of y. These are alcohol alkoxylates which comprise more alkylene oxide units than styrene oxide units.

Preferred alkoxylates in this context are those in which the ratio of alkylene oxide to styrene oxide (z to y; x to y; or (x+z) to y) is at least 1.1:1, preferably at least 1.5:1, in particular at least 2:1, especially at least 5:1 and particularly preferably at least 10:1. In accordance with a further aspect, there must be mentioned alkoxylates in which the ratio of alkylene oxide to styrene oxide (z to y; x to y; or (x+z) to y) is up to 25:1, preferably up to 20:1 and in particular up to 15:1.

According to one aspect, the degree of alkoxylation to be attributed to the styrene oxide units (value of y) is, as a rule, at least approximately 0.5, preferably at least approximately 0.9 and in particular at least approximately 1. In accordance with another aspect, the degree of alkoxylation to be attributed to the styrene oxide units (value of y) is, as a rule, not more than approximately 30, preferably not more than approximately 20 and in particular not more than 15. Specific alcohol alkoxylates of the invention have less than about 3, especially less than about 2.5 and in particular less than about 2 styrene oxide units per molecule, so that the degree of alkoxylation assigned to the styrene oxide units (value of y) is, as a rule, in the range of from about 0.5 to 2.5, preferably in the range of from about 0.9 to 2 and in particular in the range of from about 1 to 1.5. Of these, alcohol alkoxylates whose degree of alkoxylation to be attributed to the styrene oxide units (value of y) is in the range of from about 0.5 to 0.9 are of particularly special embodiment.

The degree of alkoxylation to be attributed to the alkylene oxide units (value of x, z or (x+z)) is, as a rule, at least approximately 1, preferably at least approximately 3 and in particular at least approximately 5. In accordance with another aspect, the degree of alkoxylation to be attributed to the alkylene oxide units (value of x, z or (x+z)) is, as a rule, not more than approximately 50, preferably not more than approximately 30 and in particular not more than approximately 20.

A particular embodiment are alcohol alkoxylates of the formula (I) where z is zero, i.e. alkoxylated alcohols of the formula (Ia)

R—O—(CₚH₂ₚO)_{q}-[(CₙH₂ₙO)ₓ-(PhC₂H₃O)_{y}]_{co}-Z (Ia)

where R, p, q, n, x, y, Z are as defined above and x is greater than zero.

A further particular embodiment are alcohol alkoxylates of the formula (I), where x and z are greater than zero.

The reaction of the alcohols, or alcohol mixtures, with styrene oxide and the alkylene oxide(s) is carried out by customary methods known to the skilled worker, and in apparatuses conventionally used for this purpose.

The alkoxylation can be catalyzed by strong bases such as alkali metal hydroxides and alkaline-earth metal hydroxides, Brönsted acids or Lewis acids, such as AlCl₃, BF₃ and the like. Catalysts such as hydrotalcite or DMC may be used for alcohol alkoxylates with a narrow distribution.

The alkoxylation is preferably carried out at temperatures in the range of from approximately 80 to 250° C., preferably approximately 100 to 220° C. The pressure is preferably between ambient pressure and 600 bar. If desired, the styrene oxide and/or alkylene oxide may comprise an admixture of inert gas, for example of approximately 5 to 60%.

In formulae (I) and (Ia), the alkylene oxide and styrene oxide units, if present, can be arranged as desired. The structural unit [ . . . ]_{∞} can thus be a random copolymer, a gradient copolymer, an alternating copolymer or a block copolymer made up of alkylene oxide units CₙH₂ₙO, styrene oxide units PhC₂H₃O and/or alkylene oxide units CₘH₂ₘO.

In the event that n represents a value of from 3 to 16, —CₙH₂ₙO— is either —CH(Cₙ₋₂H₂ₙ₋₃)CH₂O— (such as —CH(CH₃)CH₂O—) or —CH₂CH(CHₙ₋₂H₂ₙ₋₃)O— (such as —CH₂CH(CH₃)O—). In this context, a particular alcohol alkoxylate may essentially comprise alkylene oxide units of one or the other type, or both. An alkylene oxide block —(CₙH₂ₙO)ₓ— can be composed essentially of alkylene oxide units of the formula —CH₂CH(Cₙ₋₂H₂ₙ₋₃)O—, essentially of alkylene oxide units of the formula —CH(Cₙ₋₂H₂ₙ₋₃)CH₂O—, or of both alkylene oxide units of the formula —CH₂CH(Cₙ₋₂H₂ₙ₋₃)O— and of alkylene oxide units of the formula —CH(Cₙ₋₂H₂ₙ₋₃)CH₂O—, where, in the latter case, the two alkylene oxide units may be randomly distributed, alternating or arranged as two or more sub-blocks. In the case of base-catalyzed alkoxylation, the result is predominantly alkylene oxide units of the formula —CH₂CH(Cₙ₋₂H₂ₙ₋₃)O—, since the attack of the anion preferably takes place at the secondary carbon atom of the propylene oxide, which is less sterically hindered. Customary molar ratios are those of more than 60:40, 70:30 or 80:20, for example approximately 85:15, in favor of alkylene oxide units of the formula —CH₂CH(Cₙ₋₂H₂ₙ₋₃)O—. This also applies analogously to —CₘH₂ₘO— in the event that m represents a value of from 3 to 16.

PhC₂H₃O represents a styrene oxide unit of the formulae:

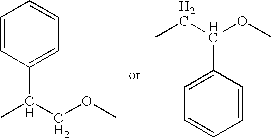

In this context, a certain alcohol alkoxylate may essentially comprise styrene oxide units of one or the other type, or both. The same applies to styrene oxide blocks, where, again, the two styrene oxide units may be randomly distributed, alternating or arranged as two or more sub-blocks. In the case of base-catalyzed alkoxylation, the result is predominantly alkylene oxide units of the formula —CH₂CH(Ph)O—, since the attack of the anion preferably takes place at the secondary carbon atom of the styrene oxide, which is less sterically hindered. Customary molar ratios are those of more than 60:40, 70:30 or 80:20, for example approximately 85:15, in favor of alkylene oxide units of the formula —CH₂CH(Ph)O—.

In accordance with a particular embodiment, the alkoxylated alcohol is selected among alcohol block alkoxylates of the formula (II)

R—O—(CₚH₂ₚO)_{q}—(CₙH₂ₙO)ₓ—(PhC₂H₃O)_{y}—(CₘH₂ₘO)_{z}Z (II)

where R, p, q, n, m, x, y, z, Z are as defined herein.

A further particular embodiment are alcohol alkoxylates of the formula (II), where x and z are greater than zero.

The alcohol block alkoxylates of the formula (II) include, in particular, alkoxylated alcohols of the formula (IIa)

R—O—(CₚH₂ₚO)_{q}-(PhC₂H₃O)_{y}—(CₘH₂ₘO)_{z}—Z (IIa),

where R, p, q, m, y, z, Z are as defined herein and z is greater than zero. These take the form of alcohol alkoxylates with a styrene oxide block and an alkylene oxide block, the alkylene oxide block being arranged in the terminal position.

The alcohol block alkoxylates of the formula (II) include, in particular, alkoxylated alcohols of the formula (IIb)

R—O—(CₚH₂ₚO)_{q}—(CₙH₂ₙO)ₓ—(PhC₂H₃O)_{y}—H (IIb),

where R, p, q, n, x, y are as defined herein and x is greater than zero. These take the form of alcohol alkoxylates with a styrene oxide block and an alkylene oxide block, the styrene oxide block being arranged in the terminal position.

One type of alcohol alkoxylates to be employed is based on styrene oxide and one type of alkylene oxide.

Another type of alcohol alkoxylates to be employed is based on styrene oxide and two different types of alkylene oxide.

In accordance with one aspect, it is preferred that the alcohol alkoxylates according to the invention are ethoxylated, or have at least one ethylene oxide block.

In accordance with a particular embodiment, the alcohol alkoxylates used, of the formula (I), (Ia), (II) or (IIb), are those in which n=2 and x is greater than zero. These take the form of alcohol alkoxylates of the EO/styrene oxide type, which includes especially those which have styrene oxide and ethylene oxide units (n=2; x>zero; z=zero, that is in particular alcohol alkoxylates of the formula (Ia)), and those which, besides styrene oxide and ethylene oxide units, also comprise units of another type of alkylene oxide (n=2; x>zero; z>zero). Among the alcohol alkoxylates of the EO/styrene oxide type, there must be mentioned especially block alkoxylates of the formula (II), which include in particular those which have a styrene oxide block and an ethylene oxide block (n=2; x>zero; z=zero, or x=zero; m=2; z>zero), those which, beside a styrene oxide block and an ethylene oxide block, comprise a further ethylene oxide block (n=2; x>zero; z>zero; m=2; z>zero), and those which, besides a styrene oxide block and an ethylene oxide block, also comprise a block of another type of alkylene oxide (n=2; x>zero; z>zero, m>2, or x>zero; n>2, m=2; z>zero). The alcohol alkoxylates with a styrene oxide block and an ethylene oxide block include in particular those of the formula (II) with a styrene oxide block bonded to the alcohol moiety (x=zero; m=2; z>zero, that is, in particular, alcohol alkoxylates of the formula (IIa)), and those of the formula (II) with an ethylene oxide block bonded to the alcohol moiety (n=2; x>zero; z=zero, that is, in particular, alcohol alkoxylates of the formula (IIb)). The alcohol alkoxylates with a styrene oxide block, an ethylene oxide block and a block of a further type of alkylene oxide include in particular those of the formula (II) with a propylene oxide block bonded to the alcohol moiety and a terminal EO block (n=3; x>zero; m=2; z>zero).

A particular embodiment are alcohol alkoxylates according to the invention which are not end-capped (Z=H).

In accordance with a further preferred embodiment, the alcohol alkoxylates according to the invention are end-capped. In this case, Z preferably represents C₁-C₄-alkyl, more preferably C₁-C₃-alkyl and in particular methyl. Other radicals which are furthermore suitable for Z are C₂-C₄-alkenyl (for example allyl), C₆-C₁₀-aryl (for example phenyl) or C₆-C₁₀-aryl-C₁-C₂-alkyl (for example benzyl), C₁-C₄-alkylcarbonyl (for example acetyl, propionyl, butyryl), C₆-C₁₀-arylcarbonyl (for example benzoyl). Tertiary alcohol residues such as 2-hydroxyisobutyl or inorganic acid groups, in particular phosphate, diphosphate or sulfate, are also suitable.

End-capped alcohol alkoxylates can be prepared in a manner known per se by reacting the non-end-capped alcohol alkoxylate with suitable reagents, for example dialkyl sulfates. Such reactions are described for example in EP-A 0 302 487 and EP-A 0 161 537, whose disclosure is herewith incorporated in its entirety by reference.

The theoretical molecular weight of alcohol alkoxylates which are suitable in accordance with the invention is, as a rule, less than 5000 g/mol. Preferred are alcohol alkoxylates with a molecular weight of less than 4000 g/mol, less than 3000 g/mol, or less than 2500 g/mol. In accordance with a particular embodiment, the molecular weight is less than 1000 g/mol.

The weight-average molecular weight of alcohol alkoxylates which are suitable in accordance with the invention is, as a rule, less than 5000 g/mol. Preferred are alcohol alkoxylates with a molecular weight of less than 4500 g/mol, less than 4000 g/mol, or less than 3500 g/mol. In accordance with a particular embodiment, the molecular weight is less than 3000 g/mol. The weight-average molecular weight data relate to the determination by means of gel permeation chromatography as described in the examples section and used for the alkoxylates disclosed in the reference examples.

The term “degree of branching” of R is defined herein in a manner known per se for the number of methyl groups in R minus 1. The same applies to Z by analogy. The degree of branching of the alkoxylate moiety results from the degree of alkoxylation and the alkylene oxides involved in the alkoxylation. The medium degree of branching is the average statistical value of the degrees of branching of all molecules of a sample.

The medium degree of branching can be determined by ¹H-NMR spectroscopically for primary and secondary alcohols as follows. For this purpose a sample of the alcohol is initially submitted to a derivatisation with trichloroacetyl isocyanate (TAI). Thereby the alcohols are converted into the esters of carbamic acid. The signals of the esterified primary alcohols are in the range of [symbol] =4.7 to 4.0 ppm, those of the esterified secondary alcohols are at about 5 ppm and water present in the sample reacts with TAI to form carbamic acid. All methyl, methylene and methine groups are in the range from 2.4 to 0.4 ppm. Thereby the signals <1 ppm are assigned to methyl groups. From the resulting spectrum the medium degree of branching (ISO index) is calculated as follows:

Iso-Index=((F(CH₃)/3)/(F(CH₂—OH)/2+F(CHR—OH)))−1

wherein F(CH₃) stands for the signal area corresponding to the methyl protons, F(CH₂—OH) for the signal area of the methylene protons in the CH₂—OH group, and F(CHR—OH) for the signal area of the methine protons of the CHR—OH group.

Amounts of component (b), i.e. of alcohol alkoxylate, on the total weight of the mean of more than 1% by weight, preferably of more than 5% by weight and in particular of more than 10% by weight, are advantageous. On the other hand, amounts of component (b) on the total weight of the mean of less than 50% by weight, preferably of less than 45% by weight and in particular of less than 40% by weight, are, as a rule, expedient.

The plant treatment active ingredient of component (a) can mean any substance whose purpose or effect it is to prevent the attack of any pest on a plant, or to safeguard against, repel or destroy the pest, or to reduce the damage caused by it in any other manner (pesticide). As has been stated at the outset, plant pests may belong to different groups of organisms; among the higher animals, a large number of important pests can be found in particular among the insects and mites, furthermore among nematodes and slugs and snails; vertebrates such as mammals and birds are of lesser importance in today's industrialized countries. A large number of groups of microbes, among which fungi, bacteria including the mycoplasmata, viruses and viroids comprise pests, and also weeds, which compete with useful plants for scarce living space and other resources, can be included among the pests in the wider sense. Pesticides comprise in particular aphicides, acaricides, desiccants, bactericides, chemosterilants, defoliants, antifeedants, fungicides, herbicides, herbicide safeners, insect attractants, insecticides, insect repellants, molluscides, nematicides, mating disruptors, plant activators, plant growth regulators, rodenticides, mammalian repellents, synergists, bird repellents and virucides.

Divided by chemical classes, pesticides comprise, in particular acylalanine fungicides, acylamino acid fungicides, aliphatic amide-organothiophosphate insecticides, aliphatic organothiophosphate insecticides, aliphatic nitrogen fungicides, amide fungicides, amide herbicides, anilide fungicides, anilide herbicides, inorganic fungicides, inorganic herbicides, inorganic rodenticides, antiauxins, antibiotic acaricides, antibiotic fungicides, antibiotic herbicides, antibiotic insecticides, antibiotic nematicides, aromatic acid fungicides, aromatic acid herbicides, arsenic herbicides, arsenic insecticides, arylalanine herbicides, aryloxyphenoxypropionic acid herbicides, auxins, avermectin acaricides, avermectin insecticides, benzamide fungicides, benzanilide fungicides, benzimidazole fungicides, benzimidazole precursor fungicides, benzimidazolylcarbamate fungicides, benzoic acid herbicides, benzofuranyl alkylsulfonate herbicides, benzofuranyl methylcarbamate insecticides, benzothiazole fungicides, benzothiopyran-organothiophosphate insecticides, benzotriazine-organothiophosphate insecticides, benzoylcyclohexanedione herbicides, bipyridylium herbicides, bridge diphenyl acaricides, bridge diphenyl fungicides, carbamate acaricides, carbamate fungicides, carbamate herbicides, carbamate insecticides, carbamate nematicides, carbanilate fungicides, carbanilate herbicides, quinolinecarboxylate herbicides, quinoline fungicides, quinone fungicides, quinoxaline acaricides, quinoxaline-organothiophosphate insecticides, quinoxaline fungicides, chitin synthesis inhibitors, chloroacetanilide herbicides, chloronicotinyl insecticides, chloropyridine herbicides, chlorotriazine herbicides, conazole fungicides, coumarin rodenticides, cyclodithiocarbamate fungicides, cyclohexene oxime herbicides, cyclo-propylisoxazole herbicides, cytokinins, diacylhydrazine insecticides, dicarboximide fungicides, dicarboximide herbicides, dichlorophenyldicarboximide fungicides, dimethylcarbamate insecticides, dinitroaniline herbicides, dinitrophenol acaricides, dinitrophenol fungicides, dinitrophenol herbicides, dinitrophenol insecticides, diphenyl ether herbicides, dithiocarbamate fungicides, dithiocarbamate herbicides, defoliants, ethylene-releasing agents, fluorine insecticides, furamide fungicides, furanilide fungicides, gibberellins, halogenated aliphatic herbicides, urea fungicides, urea herbicides, urea insecticides, urea rodenticides, molting hormones, molting hormone mimetics, molting inhibitors, heterocyclic organothiophosphate insecticides, imidazole fungicides, imidazolinone herbicides, indandione rodenticides, insect growth regulators, isoindole-organothiophosphate insecticides, isoxazole-organothiophosphate insecticides, juvenile hormones, juvenile hormone mimetics, copper fungicides, macrocyclic lactone acaricides, macrocyclic lactone insecticides, methoxytriazine herbicides, methylthiotriazine herbicides, milbemycin acaricides, milbemycin insecticides, mite growth regulators, morphactins, morpholine fungicides, nereistoxin analogs, nicotinoid insecticides, nitrile herbicides, nitroguanidine insecticides, nitromethylene insecticides, nitrophenyl ether herbicides, organochlorine acaricides, organochlorine insecticides, organochlorine rodenticides, organophosphate acaricides, organophosphate insecticides, organophosphate nematicides, organophosphorus acaricides, organophosphorus fungicides, organophosphorus herbicides, organo-phosphorus insecticides, organophosphorus nematicides, organophosphorus rodenticides, organothiophosphate acaricides, organothiophosphate insecticides, organothiophosphate nematicides, organotin acaricides, organotin fungicides, oxadiazine insecticides, oxathine fungicides, oxazole fungicides, oxime carbamate acaricides, oxime carbamate nematicides, oxime carbamate insecticides, oxime-organothiophosphate insecticides, plant-based insecticides, plant-based rodenticides, phenoxybutyric acid herbicides, phenoxyacetic acid herbicides, phenoxy herbicides, phenoxypropionic acid herbicides, phenylenediamine herbicides, phenylethyl phosphonothioate insecticides, phenylurea herbicides, phenylmethylcarbamate insecticides, phenylorganothiophosphate insecticides, phenylphenylphosphonothioate insecticides, phenyl pyrazolyl ketone herbicides, phenylsulfamide acaricides, phenylsulfamide fungicides, phosphonate acaricides, phosphonate insecticides, phosphonothioate insecticides, phosphoramidate insecticides, phosphoramidothioate acaricides, phosphoramidothioate insecticides, phosphorus diamide acaricides, phosphorus diamide insecticides, phthalate herbicides, phthalimide acaricides, phthalimide fungicides, phthalimide insecticides, picolate herbicides, polymeric dithiocarbamate fungicides, polysulfide fungicides, precocenes, pyrazole acaricides, pyrazole fungicides, pyrazole insecticides, pyrazolopyrimidine-organothiophosphate insecticides, pyrazolyloxyacetophenone herbicides, pyrazolylphenyl herbicides, pyrethroid acaricides, pyrethroid ester acaricides, pyrethroid ester insecticides, pyrethroid ether acaricides, pyrethroid ether insecticides, pyrethroid insecticides, pyridazine herbicides, pyridazinone herbicides, pyridine fungicides, pyridine herbicides, pyridine-organothiophosphate insecticides, pyridylmethylamine insecticides, pyrimidinamine acaricides, pyrimidinamine insecticides, pyrimidinamine rodenticides, pyrimidinediamine herbicides, pyrimidine-organothiophosphate insecticides, pyrimidine fungicides, pyrimidinyloxy benzoic acid herbicides, pyrimidinylsulfonylurea herbicides, pyrimidinylthiobenzoic acid herbicides, pyrrole acaricides, pyrrole fungicides, pyrrole insecticides, quaternary ammonium herbicides, strobilurin fungicides, sulfite ester acaricides, sulfonamide fungicides, sulfonamide herbicides, sulfonanilide fungicides, sulfonanilide herbicides, sulfonylurea herbicides, tetrazine acaricides, tetronate acaricides, tetronate insecticides, thiadiazole-organothiophosphate insecticides, thiadiazolylurea herbicides, thiazole fungicides, thiocarbamate acaricides, thiocarbamate fungicides, thiocarbamate herbicides, thiocarbonate herbicides, thiourea acaricides, thiourea herbicides, thiourea rodenticides, thiophene fungicides, triazine fungicides, triazine herbicides, triazinone herbicides, triazinylsulfonylurea herbicides, triazole fungicides, triazole herbicides, triazolone herbicides, triazolopyrimidine fungicides, triazolopyrimidine herbicides, triazole-organothiophosphate insecticides, uracil herbicides, valinamide fungicides, growth inhibitors, growth stimulators, growth retardants, xylylalanine fungicides.

The pesticide for use according to the invention is selected in particular among fungicides (a1), herbicides (a2) and insecticides (a3).

Fungicides comprise, for example, aliphatic nitrogen fungicides, such as butylamine, cymoxanil, dodicin, dodine, guazatine, iminoctadine; amide fungicides, such as carpropamid, chloraniformethan, cyflufenamid, diclocymet, ethaboxam, fenoxanil, flumetover, furametpyr, mandipropamid, penthiopyrad, prochloraz, chinazamid, silthiofam, triforine; in particular acylamino acid fungicides, such as benalaxyl, benalaxyl-M, furalaxyl, metalaxyl, metalaxyl-M, pefurazoate; anilide fungicides, such as benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, tiadinil; in particular benzanilide fungicides, such as benodanil, flutolanil, mebenil, mepronil, salicylanilides, tecloftalam; furanilide fungicides, such as fenfuram, furalaxyl, furcarbanil, methfuroxam; and sulfonanilide fungicides, such as flusulfamide; benzamide fungicides, such as benzohydroxamic acid, fluopicolide, tioxymid, trichlamide, zarilamid, zoxamide; furamide fungicides, such as cyclafuramid, furmecyclox; phenylsulfamide fungicides, such as dichlofluanid, tolylfluanid; sulfonamide fungicides, such as cyazofamid; and valinamide fungicides, such as benthiavalicarb, iprovalicarb; antibiotic fungicides, such as aureofungin, blasticidin-S, cycloheximide, griseofulvin, kasugamycin, natamycin, polyoxins, polyoxorim, streptomycin, validamycin; in particular strobilurin fungicides, such as azoxystrobin, dimoxystrobin, fluoxastrobin, kresoxim-methyl, metominostrobin, orysastrobin, picoxystrobin, pyraclostrobin, trifloxystrobin; aromatic fungicides, such as biphenyl, chlorodinitronaphthalene, chloroneb, chlorothalonil, cresol, dicloran, quintozene, tecnazene; benzimidazole fungicides, such as benomyl, carbendazim, chlorfenazole, cypendazole, debacarb, fuberidazole, mecarbinzid, rabenzazole, thiabendazole; benzimidazole precursor fungicides, such as furophanate, thiophanate, thiophanate methyl; benzothiazole fungicides, such as bentaluron, chlobenthiazon, TCMTB; bridge diphenyl fungicides, such as bithionol, dichlorophen, diphenylamine; carbamate fungicides, such as benthiavalicarb, furophanate, iprovalicarb, propamocarb, thiophanate, thiophanate-methyl; in particular benzimidazolylcarbamate fungicides, such as benomyl, carbendazim, cypendazole, debacarb, mecarbinzid; and carbanilate fungicides, such as diethofencarb; conazole fungicides; in particular imidazoles, such as climbazole, clotrimazole, imazalil, oxpoconazole, prochloraz, triflumizole; and triazoles, such as azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-p; copper fungicides, such as Bordeaux mixture, Burgundy mixture, Cheshunt mixture, copper acetate, copper carbonate, copper hydroxide, copper naphthenate, copper oleate, copper oxychloride, copper sulfate, copper zinc chromate, copper oxide, mancopper, cufraneb, cuprobam, oxine-copper; dicarboximide fungicides, such as famoxadon, fluoroimide; in particular dichlorophenyldicarboximide fungicides, such as chlozolinate, dichlozoline, iprodion, isovaledion, myclozolin, procymidon, vinclozolin; and phthalimide fungicides, such as captafol, captan, ditalimfos, folpet, thiochlorfenphim; dinitrophenol fungicides, such as binapacryl, dinobuton, dinocap, dinocap-4, dinocap-6, dinocton, dinopenton, dinosulfon, dinoterbon, DNOC; dithiocarbamate fungicides, such as azithiram, carbamorph, cufraneb, cuprobam, disulfuram, ferbam, metam, nabam, tecoram, thiram, ziram; in particular cyclodithiocarbamate fungicides, such as dazomet, etem, milneb; and polymeric dithiocarbamate fungicides, such as mancopper, mancozeb, maneb, metiram, polycarbamate, propineb, zineb; imidazole fungicides, such as cyazofamid, fenamidon, fenapanil, glyodin, iprodione, isovaledion, pefurazoate, triazoxide; inorganic fungicides, such as potassium azide, sodium azide, sulfur; morpholine fungicides, such as, for example, aldimorph, benzamorph, carbamorph, dimethomorph, dodemorph, fenpropimorph, flumorph, tridemorph; organophosphorus fungicides, such as ampropylfos, ditalimfos, edifenphos, fosetyl, hexylthiofos, iprobenfos, phosdiphen, pyrazophos, tolclofos-methyl, triamiphos; organotin fungicides, such as decafentin, fentin, tributyltin oxide; oxathine fungicides, such as carboxin, oxycarboxin; oxazole fungicides, such as chlozolinate, dichlozoline, drazoxolon, famoxadon, hymexazol, metazoxolon, myclozolin, oxadixyl, vinclozolin; polysulfide fungicides, such as barium polysulfide, potassium polysulfide, sodium polysulfide; pyrazole fungicides, such as furametpyr, penthiopyrad; pyridine fungicides, such as boscalid, buthiobate, dipyrithion, fluazinam, fluopicolide, pyridinitril, pyrifenox, pyroxychior, pyroxyfur; pyrimidine fungicides, such as bupirimate, cyprodinil, diflumetorim, dimethirimol, ethirimol, fenarimol, ferimzon, mepanipyrim, nuarimol, pyrimethanil, triarimol; pyrrole fungicides, such as fenpiclonil, fludioxonil, fluoroimide; quinoline fungicides, such as ethoxyquin, halacrinate, 8-hydroxyquinoline sulfate, quinacetol, quinoxyfen; quinone fungicides, such as benquinox, chloranil, dichlon, dithianon; quinoxaline fungicides, such as quinomethionate, chlorquinox, thioquinox; thiazole fungicides, such as ethaboxam, etridiazole, metsulfovax, octhilinone, thiabendazole, thiadifluor, thifluzamide; thiocarbamate fungicides, such as methasulfocarb, prothiocarb; thiophene fungicides, such as ethaboxam, silthiofam; triazine fungicides, such as anilazine; triazole fungicides, such as bitertanol, fluotrimazole, triazbutil; urea fungicides, such as bentaluron, pencycuron, quinazamid; unclassified fungicides, such as acibenzolar, acypetacs, allyl alcohol, benzalkonium chloride, benzamacril, bethoxazin, carvone, DBCP, dehydroacetic acid, diclomezine, diethyl pyrocarbonate, fenaminosulf, fenitropan, fenpropidin, formaldehyde, furfural, hexachlorobutadiene, isoprothiolane, methyl isothiocyanate, metrafenon, nitrostyrene, nitrothal-isopropyl, OCH, phthalide, piperalin, probenazole, proquinazid, pyroquilon, sodium orthophenylphenoxide, spiroxamine, sultropen, thicyofen, tricyclazole, zinc naphthenate.

In accordance with the particular embodiment of the invention, fungicides (a1) comprise:

acylalanines, such as benalaxyl, metalaxyl, ofurace, oxadixyl; amine derivatives, such as aldimorph, dodine, dodemorph, fenpropimorph, fenpropidin, guazatine, iminoctadine, spiroxamine, tridemorph;
anilinopyrimidines, such as pyrimethanil, mepanipyrim or cyprodinil; antibiotics, such as cycloheximide, giseofulvin, kasugamycin, natamycin, polyoxin and streptomycin;
azoles: azaconazole, bitertanol, bromoconazole, cyproconazole, dichiobutrazol, difenoconazole, dinitroconazole, epoxiconazole, fenbuconazole, fluquinconazole, flusilazole, flutriafol, ketoconazole, hexaconazole, metconazole, myclobutanile, penconazole, propiconazole, prothioconazole, tebuconazole, tetraconazole, triadimefone, triadimenol, triflumizole, triticonazole;
dicarboximides, such as iprodione, myclozolin, procymidon, vinclozolin;
dithiocarbamates: ferbam, nabam, maneb, mancozeb, metam, metiram, propineb, polycarbamate, thiram, ziram, zineb; heterocylic compounds, such as anilazine, benomyl, boscalid, carbendazim, carboxin, oxycarboxin, cyazofamid, dazomet, dithianon, famoxadon, fenamidon, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophanate-methyl, tiadinil, tricyclazole, triforine;
nitrophenyl derivatives, such as binapacryl, dinocap, dinobuton, nitrophthal-isopropyl; phenylpyrroles, such as fenpiclonil and fludioxonil;
2-methoxybenzophenones as described in EP-A897904, for example metrafenone; fungicides which do not belong to any other class, such as acibenzolar-5-methyl, benthiavalicarb, carpropamid, chlorothalonil, cyflufenamid, cymoxanil, diclomezine, diclocymet, diethofencarb, edifenphos, ethaboxam, fenhexamid, fentin acetate, fenoxanil, ferimzone, fluazinam, fosetyl, foestyl-aluminum, iprovalicarb, metrafenon, pencycuron, propamocarb, phthalide, toloclofos-methyl, quintozene, zoxamide;
strobilurins as described in WO03/075663, for example azoxystrobin, dimoxystrobin, fluoxastrobin, cresoxim-methyl, metominostrobin, orysastrobin, picoxystrobin, pyraclo-strobin and trifloxystrobin; sulfonates, such as captafol, captan, dichlofluanid, folpet, tolyifluanid; cinnamides and their analogs, such as dimethomorph, flumetover, flumorph;
6-aryl-[1,2,4]triazole[1,5-a]-pyrimidines as described for example in WO98/46608, WO99/41255 or WO03/004465, for example 5-chloro-7-(4-methylpiperidin-1-yl)-6-(2,4,6-trifluorophenyl)-[1,2,4]triazole[1,5-a]-pyrimidine, 5-chloro-7-(4-methylpiperazin-1-yl)-6-(2,4,6-trifluorophenyl)-[1,2,4]triazole[1,5-a]-pyrimidine, 5-chloro-7-(morpholin-1-yl)-6-(2,4,6-trifluorophenyl)-[1,2,4]triazole[1,5-a]-pyrimidine, 5-chloro-7-(piperidin-1-yl)-6-(2,4,6-trifluorophenyl)-[1,2,4]triazole[1,5-a]-pyrimidine, 5-chloro-7-(morpholin-1-yl)-6-(2,4,6-trifluorophenyl)-[1,2,4]triazole[1,5-a]-pyrimidine, 5-chloro-7-(isopropylamino)-6-(2,4,6-trifluorophenyl)-[1,2,4]triazole[1,5-a]-pyrimidine, 5-chloro-7-(cyclopentylamino)-6-(2,4,6-trifluorophenyl)-[1,2,4]-triazole[1,5-a]pyrimidine, 5-chloro-7-(2,2,2-trifluoroethyl-amino)-6-(2,4,6-trifluorophenyl)-[1,2,4]triazole[1,5-a]-pyrimidine, 5-chloro-7-(1,1,1-trifluoropropan-2-ylamino)-6-(2,4,6-trifluorophenyl)-[1,2,4]triazole[1,5-a]-pyrimidine, 5-chloro-7-(3,3-dimethylbutan-2-ylamino)-6-(2,4,6-trifluorophenyl)-[1,2,4]triazole[1,5-a]-pyrimidine, 5-chloro-7-(cyclohexylmethyl)-6-(2,4,6-trifluorophenyl)-[1,2,4]triazole[1,5-a]-pyrimidine, 5-chloro-7-(cyclohexyl)-6-(2,4,6-trifluorophenyl)-[1,2,4]triazole[1,5-a]-pyrimidine, 5-chloro-7-(2-methylbutan-3-yl)-6-(2,4,6-trifluoro-phenyl)-[1,2,4]triazole[1,5-a]-pyrimidine, 5-chloro-7-(3-methylpropan-1-yl)-6-(2,4,6-trifluorophenyl)-[1,2,4]triazole[1,5-a]-pyrimidine, 5-chloro-7-(4-methylcyclohexan-1-yl)-6-(2,4,6-trifluorophenyl)-1,2,4-triazole[1,5-a]-pyrimidine, 5-chloro-7-(hexan-3-yl)-6-(2,4,6-trifluorophenyl)-[1,2,4]triazole[1,5-a]-pyrimidine, 5-chloro-7-(2-methylbutan-1-yl)-6-(2,4,6-trifluorophenyl)-[1,2,4]triazole[1,5-a]-pyrimidine, 5-chloro-7-(3-methylbutan-1-yl)-6-(2,4,6-trifluorophenyl)-[1,2,4]triazole[1,5-a]-pyrimidine, 5-chloro-7-(1-methylpropan-1-yl)-6-(2,4,6-trifluorophenyl)-[1,2,4]triazole[1,5-a]-pyrimidine, 5-methyl-7-(4-methyl-piperidin-1-yl)-6-(2,4,6-trifluorophenyl)-[1,2,4]triazole[1,5-a]-pyrimidine, 5-methyl-7-(4-methylpiperazin-1-yl)-6-(2,4,6-trifluorophenyl)-[1,2,4]triazole[1,5-a]-pyrimidine, 5-methyl-7-(morpholin-1-yl)-6-(2,4,6-trifluorophenyl)[1,2,4]triazole[1,5-a]-pyrimidine, 5-methyl-7-(piperidin-1-yl)-6-(2,4,6-trifluorophenyl)-[1,2,4]triazole[1,5-a]-pyrimidine, 5-methyl-7-(morpholin-1-yl)-6-(2,4,6-trifluorophenyl)[1,2,4]triazole[1,5-a]-pyrimidine, 5-methyl-7-(isopropylamino)-6-(2,4,6-trifluorophenyl)-[1,2,4]triazole[1,5-a]-pyrimidine, 5-methyl-7-(cyclopentylamino)-6-(2,4,6-trifluorophenyl)-[1,2,4]triazole[1,5-a]-pyrimidine, 5-methyl-7-(2,2,2-trifluoroethylamino)-6-(2,4,6-trifluorophenyl)-[1,2,4]triazole[1,5-a]-pyrimidine, 5-methyl-7-(1,1,1-trifluoropropan-2-ylamino)-6-(2,4,6-trifluorophenyl)-[1,2,4]triazole[1,5-a]-pyrimidine, 5-methyl-7-(3,3-dimethylbutan-2-yl-amino)-6-(2,4,6-trifluorophenyl)-[1,2,4]triazole[1,5-a]-pyrimidine, 5-methyl-7-(cyclohexylmethyl)-6-(2,4,6-trifluorophenyl)-[1,2,4]triazole[1,5-a]-pyrimidine, 5-methyl-7-(cyclohexyl)-6-(2,4,6-trifluorophenyl)-[1,2,4]triazole[1,5-a]-pyrimidine, 5-methyl-7-(2-methylbutan-3-yl)-6-(2,4,6-trifluorophenyl)-[1,2,4]triazole[1,5-a]-pyrimidine, 5-methyl-7-(3-methylpropan-1-yl)-6-(2,4,6-trifluorophenyl)-[1,2,4]triazole[1,5-a]-pyrimidine, 5-methyl-7-(4-methylcyclohexan-1-yl)-6-(2,4,6-trifluorophenyl)-[1,2,4]triazole[1,5-a]-pyrimidine, 5-methyl-7-(hexan-3-yl)-6-(2,4,6-trifluorophenyl)-[1,2,4]triazole[1,5-a]-pyrimidine, 5-methyl-7-(2-methylbutan-1-yl)-6-(2,4,6-trifluorophenyl)-[1,2,4]triazole[1,5-a]-pyrimidine, 5-methyl-7-(3-methylbutan-1-yl)-6-(2,4,6-trifluorophenyl)-[1,2,4]triazole[1,5-a]-pyrimidine and 5-methyl-7-(1-methylpropan-1-yl)-6-(2,4,6-trifluorophenyl)[1,2,4]triazole[1,5-a]-pyrimidine; amide fungicides, such as cyclofenamid, and (Z)-N—[a-(cyclopropylmethoxyimino)-2,3-difluoro-6-(difluoromethoxy)benzyl]-2-phenylacetamide.

Herbicides (a2) comprise, for example, amide herbicides, such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid, tebutam; in particular anilide herbicides, such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen, propanil; in particular arylalanine herbicides, such as benzoylprop, flamprop, flamprop-M; chloroacetanilide herbicides, such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, xylachlor; and sulfonanilide herbicides, such as benzofluor, cloransulam, diclosulam, florasulam, flumetsulam, metosulam, perfluidon, pyrimisulfan, profluazole; and sulfonamide herbicides, such as asulam, carbasulam, fenasulam, oryzalin, penoxsulam; antibiotic herbicides, such as bilanafos; aromatic acid herbicides; in particular benzoate herbicides, such as chloramben, dicamba, 2,3,6-TBA, tricamba; in particular pyrimidinyloxybenzoate herbicides, such as bispyribac, pyriminobac; and pyrimidinylthiobenzoate herbicides, such pyrithiobac; phthalate herbicides, such as chlorthal; picolinate herbicides, such as aminopyralid, clopyralid, picloram; and quinolinecarboxylate herbicides, such as quinclorac, quinmerac; arsenic herbicides, such as cacodylate, CMA, DSMA, hexaflurate, MAA, MAMA, MSMA, potassium arsenite, sodium arsenite; benzoylcyclohexanedione herbicides, such as mesotrione, sulcotrione; benzofuranylalkylsulfonate herbicides, such as benfuresate, ethofumesate; carbamate herbicides, such as asulam, carboxazole, chlorprocarb, dichlormat, fenasulam, karbutilate, terbucarb; carbanilate herbicides, such as barbane, BCPC, carbasulam, carbetamid, CEPC, chlorbufam, chlorpropham, CPPC, desmedipham, phenisopham, phenmedipham, phenmedipham-ethyl, propham, swep; cyclohexene oxime herbicides, such as alloxydim, butroxydim, clethodim, cloproxydim, cycloxydim, profoxydim, sethoxydim, tepraloxydim, tralkoxydim; cyclopropylisoxazole herbicides, such as isoxachlortol, isoxaflutol; dicarboximide herbicides, such as benzfendizon, cinidon-ethyl, flumezin, flumiclorac, flumioxazin, flumipropyne; dinitroaniline herbicides, such as benfluralin, butralin, dinitramine, ethalfluralin, fluchloralin, isopropalin, methalpropalin, nitralin, oryzalin, pendimethalin, prodiamine, profluralin, trifluralin; dinitrophenol herbicides, such as dinofenat, dinoprop, dinosaur, dinoseb, dinoterb, DNOC, etinofen, medinoterb; diphenyl ether herbicides, such as ethoxyfen; in particular nitrophenyl ether herbicides, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, oxyfluorfen; dithiocarbamate herbicides, such as dazomet, metam; haloaliphatic herbicides, such as alorac, chloropon, dalapon, flupropanate, hexachloroacetone, chloroacetic acid, SMA, TCA; imidazolinone herbicides, such as imazamethabenz, imazamox, imazapic, imazapyr, imazaquin, imazethapyr; inorganic herbicides, such as ammonium sulfamate, calcium chlorate, copper sulfate, iron sulfate, potassium azide, pottassium cyanide, sodium azide, sodium chlorate, sulfuric acid; nitrile herbicides, such as bromobonil, bromoxynil, chloroxynil, dichlobenil, iodobonil, ioxynil, pyraclonil; organophosphorus herbicides, such as amiprofos-methyl, anilofos, bensulide, bilanafos, butamifos, 2,4-DEP, DMPA, EBEP, fosamine, glufosinate, glyphosate, piperophos; phenoxy herbicides, such as bromofenoxim, clomeprop, 2,4-DEB, 2,4-DEP, difenopentene, disul, erbon, etnipromid, fenteracol, trifopsime; in particular phenoxyacetic acid herbicides, such as 4-CPA, 2,4-D, 3,4-DA, MCPA, MCPA-thioethyl; phenoxybutyric acid herbicides, such as 4-CPB, 2,4-DB, 3,4-DB, MCPB, 2,4,5-TB; and phenoxypropionic acid herbicides, such cloprop, 4-CPP, dichlorprop, dichlorprop-P, 3,4-DP, fenoprop, mecoprop, mecoprop-P; in particular aryloxyphenoxypropionic acid herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop; phenylenediamine herbicides, such as dinitramine, prodiamine; phenyl pyrazolyl ketone herbicides, such as benzofenap, pyrazolynate, pyrazoxyfen, topramezone; pyrazolylphenyl herbicides, such as fluazolate, pyraflufen; pyridazine herbicides, such as credazin, pyridafol, pyridate; pyridazinone herbicides, such as brompyrazon, chloridazon, dimidazon, flufenpyr, metflurazon, norflurazon, oxapyrazon, pydanon; pyridine herbicides, such as aminopyralid, cliodinate, clopyralid, dithiopyr, fluoroxypyr, haloxydine, picloram, picolinafen, pyriclor, thiazopyr, triclopyr; pyrimidinediamine herbicides, such as iprymidam, tioclorim; quaternary ammonium herbicides, such as cyperquat, diethamquat, difenzoquat, diquat, morfamquat, paraquat; thiocarbamate herbicides, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate; thiocarbonate herbicides, such as dimexano, EXD, proxan; thiourea herbicides, such as methiuron; triazine herbicides, such as dipropetryne, triaziflam, trihydroxytriazine; in particular chlorotriazine herbicides, such as atrazine, chlorazine, cyanazine, cyprazine, eglinazine, ipazine, mesoprazine, procyazine, proglinazine, propazine, sebuthylazine, simazine, terbuthylazine, trietazine; methoxytriazine herbicides, such as atraton, methometon, prometon, secbumeton, simeton, terbumeton; and methylthiotriazine herbicides, such as ametryn, aziprotryne, cyanatryn, desmetryn, dimethametryn, methoprotryne, prometryn, simetryn, terbutryne; triazinone herbicides, such as ametridione, amibuzin, hexazinone, isomethiozin, metamitron, metribuzin; triazole herbicides, such as amitrole, cafenstrol, epronaz, flupoxam; triazolone herbicides, such as amicarbazone, carfentrazone, flucarbazone, propoxycarbazone, sulfentrazone; triazolopyrimidine herbicides, such as cloransulam, diclosulam, florasulam, flumetsulam, metosulam, penoxsulam; uracil herbicides, such as butafenacil, bromacil, flupropacil, isocil, lenacil, terbacil; urea herbicides, such as benzthiazuron, cumyluron, cycluron, dichloral urea, diflufenzopyr, isonoruron, isouron, methabenzthiazuron, monisouron, noruron; in particular phenylurea herbicides, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron, thidiazuron; sulfonylurea herbicides; in particular pyrimidinylsulfonylurea herbicides, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, trifloxysulfuron; and triazinylsulfonylurea herbicides, such as chlorsulfuron, cinosulfuron, ethametsulfuron, iodosulfuron, metsulfuron, prosulfuron, thifensulfuron, triasulfuron, tribenuron, triflusulfuron, tritosulfuron; and thiadiazolylurea herbicides, such as buthiuron, ethidimuron, tebuthiuron, thiazafluoron, thidiazuron; and other herbicides, such as acrolein, allyl alcohol, azafenidin, benazolin, bentazon, benzobicyclon, buthidazole, calcium cyanamide, cambendichlor, chlorfenac, chlorfenprop, chlorfiurazole, chlorflurenol, cinmethylin, clomazone, CPMF, cresol, orthodichlorobenzene, dimepiperate, endothal, fluoromidine, fluridon, fluorochloridon, flurtamon, fluthiacet, indanofan, methazole, methyl isothiocyanate, nipyraclofen, OCH, oxadiargyl, oxadiazon, oxaziclomefon, pentoxazon, pinoxaden, prosulfalin, pyribenzoxim, pyriftalid, quinoclamine, rhodethanil, sulglycapin, thidiazimin, tridiphane, trimeturon, tripropindan, tritac.

In accordance with a particular embodiment of the invention, herbicides (a2) comprise:

1,3,4-thiadiazoles, such as buthidazole and cyprazole;
amides, such as allidochlor, benzoylprop-ethyl, bromobutide, chlorthiamid, dimepiperate, dimethenamid, diphenamid, etobenzanid, flamprop, flamprop-methyl, fosamine, isoxaben, metazachlor, monalid, naptalam, pronamide, propanil, propyzamide, quinonamide;
aminotriazoles, such as amitrole, anilides, such as anilofos, mefenacet, pentanochlor;
aryloxyalkanoic acids, such as 2,4-D, 2,4-DB, clomeprop, dichlorprop, dichlorprop-P, fenoprop, fluoroxypyr, MCPA, MCPB, mecoprop, mecoprop-P, napropamide, napropanilide, triclopyr;
benzoic acids, such as chloramben, dicamba;
benzothiadiazinones, such as bentazone;
bleaches, such as clomazone, diflufenican, fluorochloridone, flupoxam, fluridone, karbutilate, pyrazolate, sulcotrione, mesotrione;
carbamates, such as asulam, carbetamide, chlorbufam, chlorpropham, desmedipham, phenmedipham, vernolate;
quinolates, such as quinclorac, quinmerac; dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin;
dinitrophenols, such as bromofenoxim, dinoseb, dinoseb-acetate, dinoterb, DNOC, minoterb-acetate;
diphenyl ethers, such as acifluorofen, acifluorfen-sodium, aclonifen, bifenox, chlornitrofen, difenoxuran, ethoxyfen, fluorodifen, fluoroglycofen-ethyl, fomesafen, furyloxyfen, lactofen, nitrofen, nitrofluorfen, oxyfluorfen;
ureas, such as benzthiazuron, DCU, diflufenzopyr, methabenzthiazuron;
imidazolinones, such as imazamethapyr, imazapyr, imazaquin, imazethabenz-methyl, imazethapyr, imazapic, imazamox;
oxadiazoles, such as methazole, oxadiargyl, oxadiazon;
oxiranes, such as tridiphane;
phenols, such as bromoxynil, loxynil;
phenoxyphenoxypropionic acid acid esters, such as clodinafop, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl, quizalofop-tefuryl; phenylacetic acids, such as chlorfenac;
phenylureas, such as buturon, chlorotoluron, chlorbromuron, chloroxuron, dimefuron, diuron, fenuron, isoproturon, linuron, monolinuron, monuron, metobenzuron, metobromuron, metoxuron, neburon;
phenylpropionic acids, such as chlorophenprop-methyl;
ppi-active compounds, such as benzofenap, flumichlorac, flumiclorac-pentyl, flumioxazin, flumipropyn, flupropacil, pyrazoxyfen, sulfentrazone, thidiazimin;
pyrazole, such as nipyraclofen;
pyridazines, such as chloridazone, maleic hydrazide, norflurazone, pyridate;
pyridinecarboxylates, such as clopyralid, dithiopyr, picloram, thiazopyr; pyrimidyl ethers, such as pyrithiobac-acid, pyrithiobac-sodium, KIH-2023, KIH-6127;
sulfonamides, such as flumetsulam, metosulam; sulfonylureas, such as amidosulfuron, azimsulfuron, bensulfuron-methyl, chlorimuron-ethyl, chlorsulfuron, cinosulfuron, cyclosulfamuron, ethoxysulfuron, ethametsulfuron-methyl, flazasulfuron, flupyrsulfuron-methyl, foramsulfuron, halosulfuron-methyl, imazosulfuron, idosulfuron, metsulfuron-methyl, nicosulfuron, oxasulfuron, primisulfuron, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, tritosulfuron;
thiadiazolylureas, such as ethidimuron, tebuthiuron, thiazafluoron; triazines, such as ametryn, atrazine, atraton, cyanazine, cyprazine, desmetryn, dipropetryn, isomethiozin, propazine, promethryn, prometon, sebuthylazine, secbumethon, simazine, tebutryn, terbumeton, terbuthylazine, trietazine;
triazolearboxamides, such as triazofenamid; uracils, such as bromacil, butafenacil, lenacil, terbacil; furthermore azafenidin, aziprotryne, bromuron, benazolin, benfuresate, bensulide, benzofluor, bentazon, bromofenoxim, butamifos, cafenstrol, chlorthal-dimethyl, cinmethylin, cinidon-ethyl, defenuron, dichlobenil, endothall, fluorbentranil, fluthiacet-methyl, inxynil, isoxaflutol, mefluidide, methazol, metribuzin, metramitron, perfluidon, piperophos, topramezone;
crop protection agents of the cyclohexenone type, such as alloxydim, clethodim, cloproxydim, cycloxydim, sethoxydim and tralkoxydim.

Especially preferred crop protection agents of the cyclohexenone type comprise tepraloxydim (cf. AGROW, No. 243, 3.11.95, p. 21, Caloxydim) and 2-(1-[2-{4-chlorophenoxy}propyloxyimino]butyl)-3-hydroxy-5-(2h-tetrahydrothiopyran-3-yl)-2-cyclohexen-1-one, and a particularly preferred herbicidally active compound of the sulfonylurea type is N-(((4-methoxy-6-[trifluoromethyl]-1,3,5-triazin-2-yl)amino)-carbonyl)-2-(trifluoromethyl)benzenesulfonamide.

Insecticides (a3) comprise, for example, antibiotics-insecticides, such as allosamidin, thuringiensin; in particular macrocyclic lactone insectidies, such as spinosad; in particular vermectin insecticides, such as abamectin, doramectin, emamectin, eprinomectin, ivermectin, selamectin; and milbemycin insecticides, such as lepimectin, milbemectin, milbemycin-oxime, moxidectin; arsenic insecticides, such as calcium arsenate, copper acetarsenite, copper arsenate, lead arsenate, potassium arsenite, sodium arsenite; plant-based insecticides, such as anabasin, azadirachtin, D-limonene, nicotin, pyrethrins, cinerin E, cinerin I, cinerin II, jasmolin I, jasmolin II, pyrethrin I, pyrethrin II, quassia, rotenone, ryania, sabadilla; carbamate insecticides, such as bendiocarb, carbaryl; in particular benzofuranyl methylcarbamate insecticides, such as benfuracarb, carbofuran, carbosulfan, decarbofuran, furathiocarb; dimethylcarbamate insecticides, such as dimetan, dimetilan, hyquincarb, pirimicarb; oxime carbamate insecticides, such as alanycarb, aldicarb, aldoxycarb, butocarboxim, butoxycarboxim, methomyl, nitrilacarb, oxamyl, tazimcarb, thiocarboxime, thiodicarb, thiofanox; and phenyl methylcarbamate insecticides, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb; dinitrophenol insecticides, such as dinex, dinoprop, dinosam, DNOC; insect growth regulators; in particular chitin synthesis inhibitors, such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron, triflumuron; juvenile hormone mimetics, such as epofenonane, fenoxycarb, hydroprene, kinoprene, methoprene, pyriproxyfen, triprene; juvenile hormones, such as juvenile hormone I, II and III; molting hormone agonists, such as chromafenozide, halofenozide, methoxyfenozide, tebufenozide; molting hormones, such as α-ecdysone, ecdysterone; molting inhibitors, such as diofenolan; precocenes, such as precocene I, precocene II and precocene III; and unclassified insecticides, such as dicyclanil; nereistoxin analogs, such as bensultap, cartap, thiocyclam, thiosultap; nicotinoid insecticides, such as flonicamid; in particular nitroguanidine-insecticides, such as clothianidin, dinotefuran, imidacloprid, thiamethoxam; nitromethyl-lene insecticides, such as nitenpyram, nithiazine; and pyridylmethylamine insecticides, such as acetamiprid, imidacloprid, nitenpyram, thiacloprid; organochlorine insecticides, such as isobenzan, isodrin, kelevan, mirex; organophosphorus insecticides; in particular organophosphate insecticides, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP, tetrachlorvinphos; organothiophosphate insecticides, such as dioxabenzofos, fosmethilan, phenthoate; in particular aliphatic organothiophosphate insecticides, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos, thiometon; in particular aliphatic amideorganothiophosphate insecticides, such as amidithion, cyanthoate, dimethoate, ethoate-methyl, formothion, mecarbam, omethoate, prothoate, sophamide, vamidothion; and oximeorganothiophosphate insecticides, such as chlorphoxim, phoxim, phoxim-methyl; heterocyclic organothiophosphate insecticides, such as azamethiphos, coumaphos, coumithoate, dioxathion, endothion, menazon, morphothion, phosalon, pyraclofos, pyridaphenthion, quinothion; especially benzothiopyran-organothiophosphate insecticides, such as dithicrofos, thicrofos; benzotriazine organothiophosphate insecticides, such as azinphos-ethyl, azinphos-methyl; isoindole organothiophosphate insecticides, such as dialifos, phosmet; isoxazole organothiophosphate insecticides, such as isoxathion, zolaprofos; pyrazolopyrimidine organothiophosphate insecticides, such as chlorprazophos, pyrazophos; pyridine organothiophosphate insecticides, such as chlorpyrifos, chlorpyrifos-methyl; pyrimidine organothiophosphate insecticides, such as butathiofos, diazinon, etrimfos, lirimfos, pirimiphos-ethyl, pirimiphos-methyl, primidophos, pyrimitate, tebupirimfos; quinoxaline organothiophosphate insecticides, such as quinalphos, quinalphos-methyl; thiadiazole organothiophosphate insecticides, such as athidathion, lythidathion, methidathion, prothidathion; and triazole organothiophosphate insecticides, such as isazofos, triazophos; and phenyl organothiophosphate insecticides, such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos; phosphonate insecticides, such as butonate, trichlorfon; phosphonothioate-insecticides, such as mecarphon; in particular phenyl ethylphosphonothioate-insecticides, such as fonofos, trichloronat; and phenyl phenylphosphonothioate insecticides, such as cyanofenphos, EPN, leptophos; phosphoramidate insecticides, such as crufomate, fenamiphos, fosthietan, mephosfolan, phosfolan, pirimetaphos; phosphoramidothioate insecticides, such as acephate, isocarbophos, isofenphos, methamidophos, propetamphos; and phosphorodiamide insecticides, such as dimefox, mazidox, mipafox, schradan; oxadiazine insecticides, such as indoxacarb; phthalimide insecticides, such as dialifos, phosmet, tetramethrin; pyrazole insecticides, such as acetoprol, ethiprol, fipronil, pyrafluprol, pyriprol, tebufenpyrad, tolfenpyrad, vaniliprole; pyrethroid insecticides; in particular pyrethroid ester insecticides, such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, taufluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin; and pyrethroid ether insecticides, such as etofenprox, flufenprox, halfenprox, protrifenbute, silafluofen; pyrimidinamine insecticides, such as flufenerim, pyrimidifen; pyrrole insecticzides, such as chlorfenapyr; tetronic acid insecticides, such as spiromesifen; thiourea insecticides, such as diafenthiuron; urea insecticides, such as flucofuron, sulcofuron; unclassified insecticides, such as closantel, crotamiton, EXD, fenazaflor, fenoxacrim, flubendiamide, hydramethylnon, isoprothiolane, malonoben, metaflumizon, metoxadiazon, nifluridide, pyridaben, pyridalyl, rafoxanide, triarathene, triazamate.

In accordance with a particular embodiment of the present invention, insectidies (a3) comprise:

organophosphates, such as azinphos-methyl, azinphos-ethyl, chlorpyrifos, chlorpyrifosmethyl, chlorfenvinphos, diazinon, dimethylvinphos, dioxabenzofos, disulfoton, ethion, EPN, fenitrothion, fenthion, heptenophos, isoxathion, malathion, methidathion, methylparathion, paraoxon, parathion, phenthoate, phosalon, phosmet, phorate, phoxim, pirimiphos-methyl, profenofos, prothiofos, primiphos-ethyl, pyraclofos, pyridaphenthion, sulprofos, triazophos, trichlorfon, tetrachlorvinphos, vamidothion;
carbamates, such as alanycarb, benfuracarb, bendiocarb, carbaryl, carbofuran, carbosulfan, fenoxycarb, furathiocarb, indoxacarb, methiocarb, pirimicarb, propoxur, thiodicarb, triazamate;
pyrethroids, such as bifenthrin, cyfluthrin, cycloprothrin, cypermethrin, deltamethrin, esfenvalerat, ethofenprox, fenpropathrin, fenvalerate, cyhalothrin, lambda-cyhalothrin, permethrin, silafluofen, tau-fluvalinate, tefluthrin, tralomethrin, alpha-cypermethrin,
permethrin;
arthropod growth regulators:
chitin synthesis inhibitors, for example benzoylureas, such as chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine;
ecdysone antagonists, such as halofenozide, methoxyfenozide, tebufenozide;
juvenoids, such as pyriproxyfen, methoprene;
lipid biosynthesis inhibitors, such as spirodiclofen;
neonicotinoids, such as flonicamid, clothianidin, dinotefuran, imidacloprid, thiamethoxam, nithiazine, acetamiprid, thiacloprid;
other insecticides which do not belong to the above classes, such as abamectin, acequinocyl, acetamiprid, azadirachtin, bensultap, bifenazate, cartap, chlorfenapyr, diafenthiuron, dinetofuran, diofenolan, emamectin, ethiprole, fenazaquin, fipronil, hydramethylnon, imidacloprid, indoxacarb, isoprocarb, metolcarb, pyridaben, pymetrozine, spinosad, tebufenpyrad, thiamethoxam, xmc and xylylcarb, and N-phenylsemicarbazones as described in EP-A462-456, in particular compounds of the general formula (IV)

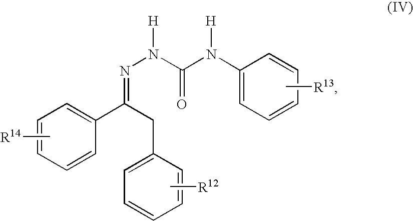

where R¹² and R¹⁴ independently of one another can represent hydrogen, halogen, CN, C₁-C₄-alkyl, C₁-C₄-alkoxy, C₁₋₄-haloalkyl or C₁₋₄-haloalkoxy and R¹³ C₁₋₄-alkoxy, C₁₋₄-haloalkyl or C₁₋₄-haloalkoxy, for example compounds according to formula (IV) in which R¹⁴=3-CF₃, R¹²=4-CN and R¹³=4-OCF₃.

It is also possible to employ salts, in particular agriculturally useful salts, of the active ingredients mentioned specifically in this context.

In a particular embodiment of the invention, the plant protection agent is a fungicide.

It is especially preferred in this context that the fungicide is an active ingredient selected from the group of the anilides, triazolopyrimidines, strobilurins or triazoles, in particular an anilide selected among boscalid, carboxin, metalaxyl and oxadixyl, the triazolopyrimidine 5-chloro-7-(4-methylpiperidin-1-yl)-6-(2,4,6-trifluorophenyl)-[1,2,4]triazol[1,5-a]-pyrimidine, a strobilurin selected among azoxystrobin, pyraclostrobin, dimoxystrobin, trifloxystrobin, fluoxystrobin, picoxystrobin and orysastrobin, or a triazole selected among epoxiconazole, metconazole, tebuconazole, flusilazol, fluquinconazole, triticonazole, propiconazole, penconazole, cyproconazole and prothioconazole.

Especially preferred in accordance with the invention is the use of epoxiconazole.

The names chosen here, of plant protection agents, for example epoxiconazole, include isomeric forms of this compound. Stereoisomers, such as enantiomers or diastereoisomers of the formulae, must be mentioned in particular. In addition to the essentially pure isomers, the compounds of the formulae also include their isomer mixtures, for example stereoisomer mixtures.

Active ingredients with a higher content of the stereoisomer which is biologically more active than the optical antipode, especially preferably isomerically pure active ingredients, are generally preferred.

The present invention particularly relates to compositions with high active-ingredient contents (concentrates). Thus, component (a) will, as a rule, amount to more than 5% by weight, preferably more than 10% by weight and in particular more than 20% by weight of the total weight of the composition. On the other hand, component (a) will expediently amount, as a rule, to less than 80% by weight, preferably less than 70% by weight and in particular less than 60% by weight of the total weight of the composition.

In order to ensure sufficient adjuvant effect, the weight ratio of component (b) to component (a) is preferably more than 0.5, in particular more than 1 and advantageously more than 2.

Furthermore, the compositions according to the invention may comprise auxiliaries and/or additives which are customary for the preparation of formulations in the agrochemical sector, and in particular in the crop protection sector. These include, for example, surfactants, dispersants, wetters, thickeners, organic solvents, cosolvents, antifoams, carboxylic acids, preservatives, stabilizers and the like.

In accordance with a particular embodiment of the present invention, the compositions comprise, as surface-active component (c), at least one (further) surfactant. In this context, the term “surfactant” refers to interface-active or surface-active agents.

Component (c) is added in particular as a dispersant or emulsifier, mainly to disperse a solid component in suspension concentrates. Component (c) may furthermore act in part as wetter.

Substances which are useful in principle are anionic, cationic, amphoteric and nonionic surfactants, with polymer surfactants and surfactants with heteroatoms in the hydrophobic group being included.

The anionic surfactants include, for example, carboxylates, in particular alkali metal, alkaline earth metal and ammonium salts of fatty acids, for example potassium stearate, which are usually also referred to as soaps; acyl glutamates; sarcosinates, for example sodium lauroyl sarcosinate; taurates; methylcelluloses; alkyl phosphates; in particular alkyl esters of mono- and diphosphoric acid; sulfates, in particular alkyl sulfates and alkyl ether sulfates; sulfonates, furthermore alkyl- and alkylarylsulfonates; in particular alkali metal, alkaline earth metal and ammonium salts of arylsulfonic acids, and alkyl-substituted arylsulfonic acids, alkylbenzenesulfonic acids, such as, for example, lignosulfonic and phenolsulfonic acid, naphthalene- and dibutylnaphthalene-sulfonic acids, or dodecylbenzenesulfonates, alkylnaphthalenesulfonates, alkyl methyl estersulfonates, condensates of sulfonated naphthalene and derivatives thereof with formaldehyde, condensates of naphthalenesulfonic acids, phenolic and/or phenolsulfonic acids with formaldehyde or with formaldehyde and urea, mono- or dialkylsuccinicestersulfonates; and protein hydrolyzates and lignin-sulfite waste liquors. The abovementioned sulfonic acids are advantageously used in the form of their neutral or, if appropriate, basic salts.

The cationic surfactants include, for example, quaternized ammonium compounds, in particular alkyltrimethylammonium and dialkyldimethylammonium halides and alkyltrimethylammonium and dialkyldimethylammonium alkyl sulfates, and pyridine and imidazoline derivatives, in particular alkylpyridinium halides.

The nonionic surfactants include, for example, further alkoxylates and especially ethoxylates, and nonionic surfactants, in particular
fatty alcohol polyoxyethylene esters, for example lauryl alcohol polyoxyethylene ether acetate;
alkyl polyoxyethylene ethers and alkyl polyoxypropylene ethers, for example of fatty alcohols having 8 or more carbon atoms,
alkylaryl alcohol polyoxyethylene ethers, for example octylphenol polyoxyethylene ether,
alkoxylated animal and/or vegetable fats and/or oils, for example, corn oil ethoxylates, castor oil ethoxylates, tallow fat ethoxylates,
glycerol esters, such as, for example, glycerol monostearate,
alkylphenol alkoxylates, such as, for example, ethoxylated iso-octylphenol, octylphenol or nonylphenol, tributylphenol polyoxyethylene ether,
fatty amine alkoxylates, fatty acid amide alkoxylates and fatty acid diethanolamide alkoxylates, in particular their ethoxylates,
sugar surfactants, sorbitol esters, such as, for example sorbitan fatty acid esters (sorbitan monooleate, sorbitan tristearate), polyoxyethylene sorbitan fatty acid esters, alkyl polyglycosides, N-alkylgluconamides,
alkylmethylsulfoxides,
alkyldimethylphosphine oxides, such as, for example, tetradecyldimethyl-phosphine oxide.

The amphoteric surfactants include, for example, sulfobetains, carboxybetains and alkyldimethylamine oxides, for example tetradecyldimethylamine oxide.

The polymeric surfactants include, for example, di-, tri-, and multiblock polymers of the type (AB)ₓ, ABA and BAB, e.g. if appropriate end-group-closed ethylene-oxide/propylene oxide block copolymers, e.g. ethylene diamine/EO/PO block copolymers, polystyrene/block/polyethylene oxide, and AB comb polymers, e.g. polymethacrylate/comb/polyethylene oxide.

Further surfactants to be mentioned by way of example in this context are perfluorine surfactants, silicone surfactants, for example polyether-modified siloxanes, phospholipids, such as, for example, lecithin or chemically modified lecithins, amino acid surfactants, for example N-lauroylglutamate, and surface-active homo- and copolymers, for example polyvinylpyrrolidone, polyacrylic acids in the form of their salts, polyvinyl alcohol, polypropylene oxide, polyethylene oxide, maleic anhydride/isobutene copolymers and vinylpyrrolidone/vinyl acetate copolymers.

Unless specified, the alkyl chains of the abovementioned surfactants are linear or branched radicals having, usually, 8 to 20 carbon atoms.

The further surfactant within the scope of component (c) is preferably selected among nonionic surfactants. Among these, surfactants with HLB values in the range from 2 to 16, preferably in the range from 5 to 16 and in particular in the range of from 8 to 16, are preferred.

Component (c)—if present—will, as a rule, amount to less than 50% by weight, preferably less than 15% by weight and in particular less than 5% by weight of the total weight of the composition.

In accordance with a particular embodiment of the present invention, the compositions comprise, as component (d), at least one further auxiliary.

Component (d) may serve a multitude of purposes. The skilled worker will choose suitable auxiliaries in the customary manner to meet the specific requirements.

For example, further auxiliaries are selected among

(d1) solvents or diluents;
(d2) retention agents, pH buffers, antifoams.

Besides water, the compositions may comprise further solvents of soluble constituents, or diluents for insoluble constituents of the composition.

Substances which are useful in principle are, for example, mineral oils, synthetic oils and vegetable and animal oils, and low-molecular-weight hydrophilic solvents such as alcohols, ethers, ketones and the like.

Substances which must therefore be mentioned are, firstly, aprotic or apolar solvents or diluents, such as mineral oil fractions of medium to high boiling point, for example kerosene and diesel oil, furthermore coal tar oils, hydrocarbons, liquid paraffins, for example C₈- to C₃₀-hydrocarbons of the n- or iso-alkane series or mixtures of these, if appropriate, hydrogenated or partially hydrogenated aromatics or alkyl aromatics from the benzene or naphthalene series, for example aromatic or cycloaliphatic C₇- to C₁₈-hydrocarbon compounds, aliphatic or aromatic carboxylic acid or dicarboxylic acid esters, fats or oils of vegetable or animal origin, such as mono-, di- and triglycerides, in pure form or as a mixture, for example in the form of oily extracts from natural substances, for example olive oil, soy oil, sunflower oil, castor oil, sesame oil, corn oil, peanut oil, rapeseed oil, linseed oil, almond oil, castor oil, safflower oil, and their raffinates, for example hydrogenated or partially hydrogenated products thereof and/or their esters, in particular methyl and ethyl esters.

Examples of C₈- to C₃₀-hydrocarbons of the n- or iso-alkane series are n- and iso-octane, -decane, -hexadecane, -octadecane, -eicosane, and preferably hydrocarbon mixtures, such as liquid paraffin (which, if industrial-grade, may comprise up to approximately 5% aromatics) and a C₁₈-C₂₄-mixture which is commercially obtainable from Texaco under the name Spraytex oil.

The aromatic or cycloaliphatic C₇- to C₁₈-hydrocarbon compounds include, in particular, aromatic or cycloaliphatic solvents from the series of the alkyl aromatics. These compounds may be unhydrogenated, partially hydrogenated or fully hydrogenated. Such solvents include, in particular, mono-, di- or trialkylbenzenes, mono-, di-, trialkyl-substituted tetralins and/or mono-, di-, tri- or tetraalkyl-substituted naphthalenes (alkyl preferably represents C₁-C₆-alkyl). Examples of such solvents are toluene, o-, m-, p-xylene, ethylbenzene, isopropylbenzene, tert-butylbenzene and mixtures, such as the products from Exxon sold under the names Shellsol and Solvesso, for example Solvesso 100, 150 and 200.

Examples of suitable monocarboxylic acid esters are oleic esters, in particular methyl oleate and ethyl oleate, lauric acid esters, in particular 2-ethylhexyl laurate, octyl laurate and isopropyl laurate, isopropyl myristate, palmitic acid esters, in particular 2-ethylhexyl palmitate and isopropyl palmitate, stearic acid esters, in particular n-butyl stearate and 2-ethylhexyl 2-ethylhexanoate.

Examples of suitable dicarboxylic acid esters are adipic acid esters, in particular dimethyl adipate, di-n-butyl adipate, di-n-octyl adipate, di-iso-octyl adipate, also referred as bis-(2-ethylhexyl) adipate, di-n-nonyl adipate, di-iso-nonyl adipate and ditridecyl adipate; succinic acid esters, in particular di-n-octyl succinate and di-iso-octyl succinate, and di-(iso-nonyl)cyclohexane-1,2-dicarboxylate.

As a rule, the above-described aprotic solvents or diluents amount to less than 80%, preferably less than 50% and in particular less than 30% of the total weight of the composition.

Some of these aprotic solvents or diluents can also have adjuvant properties, i.e. in particular activity-enhancing properties. This applies in particular to said mono- and dicarboxylic acid esters. In accordance with this aspect, such adjuvants may also, as part of another formulation (stand-alone product), be mixed with the alcohol alkoxylates according to the invention, or with compositions comprising them, at a suitable point in time, as a rule shortly before application.

Secondly, protic or polar solvents or diluents must be mentioned, for example C₂-C₈-mono alcohols, such as ethanol, propanol, isopropanol, butanol, isobutanol, tert-butanol, cyclohexanol and 2-ethylhexanol, C₃-C₈-ketones, such as diethyl ketone, t-butyl methyl ketone, cyclohexanone and 2-sec-butylphenol, and aprotic amines, such as N-methyl- and N-octylpyrrolidone.

As a rule, the above-described protic or polar solvents or diluents amount to less than 80%, preferably less than 50% and in particular less than 30% of the total weight of the composition.

It is also possible to use antisettling agents, in particular for suspension concentrates. Such antisettling agents serve in particular the purpose of rheological stabilization. Substances which must be mentioned in this context are, in particular, mineral products, for examples bentonites, talcites and hectorites.

Other additives which may be useful can be found for example among mineral salt solutions, which are employed for alleviating nutritional and trace element deficiencies, nonphytotoxic oils and oil concentrates, antidrift reagents, antifoams, in particular those of the silicone type, for example Silicon SL, which is commercially obtainable from Wacker, and the like.

The formulations may be present as water-soluble concentrates (SL, LS), dispersible concentrates (DC), emulisifiable concentrates (EC), emulsions (EW, EO, ES), suspensions (SC, OD, FS), water-dispersible granules (WG, SG), water-dispersible or water-soluble powders (WP, SP, SS, WS) granules (GR, FG, GG, MG), ULV solutions (UL) or gel formulations (GF).

In accordance with a preferred embodiment, the compositions according to the invention are liquid formulations.

The compositions can be prepared in a manner known per se. To this end, at least some of the components are combined. It must be noted that products, in particular commercially available products, can be used whose constituents may contribute to different components. For example, a specific surfactant may be dissolved in an aprotic solvent, so that this product may contribute to various components. Furthermore, it is also possible, under certain circumstances, that small amounts of less desired substances are introduced together with commercially available products. As a mixture, the combined products must then, as a rule, be mixed finely with one another to give a homogeneous mixture and, if required, ground, for example in the case of suspensions.

Mixing can be effected in a manner known per se, for example by homogenizing with suitable devices such as KPG or magnetic stirrers.

Grinding, too, is a process which is known per se. Grinding media which may be employed are grinding media made of glass, or other mineral or metallic grinding media, as a rule in a size of from 0.1-30 mm and in particular of from 0.6-2 mm. As a rule, the mixture is ground until the desired particle size has been reached.

In general, grinding may be effected in the circulating mode, i.e. continuous recirculating of, for example, an SC, or by means of the batch mode, i.e. complete and repeated pumping through, or passing through, of a batch.

Grinding can be effected by means of traditional ball, bead or agitated-ball mills, for example in a Dyno-mill (from Bachofen), with batch sizes of from, for example, 0.5 up to 1 liter in what is known as the batch mode. After several batches, in particular 4 to 6 passes, (pumping the suspension through the mill with the aid of a roller pump), particle sizes of from 0.5 to 10 mm are achieved, according to evaluation under the microscope.

Before use, the compositions are converted into a suitable application form in the customary manner, as a rule by dilution. Dilution with water or else aprotic solvents, for example in the tank mix method, is preferred. The use in the form of a spray mixture preparation is preferred. It may be applied pre- or post-emergence. Post-emergence application leads to particular advantages.

The use according to the invention also comprises the use of the alkoxylates according to the invention as stand-alone product. To this end, the alkoxylates are prepared in a suitable manner in order to be added, shortly before application, to the product to be applied. As regards the ratio between alkoxylate and active ingredient, what has been said above in connection with the composition also applies here. In this sense, the combination according to the invention of active ingredient and adjuvant may also be provided in the form of a kit. Such a kit comprises at least two containers. One container comprises at least one active ingredient for the treatment of plants, if appropriate formulated as a composition together with expedient auxiliaries. A further container comprises at least one alcohol alkoxylate of the formula (I).

Particular advantages result especially in the case of a spray application. For a conventional tank-mix spray mixture, the compositions, which already comprise an alkoxylated branched alcohol,—or further plant treatment compositions with the addition of at least one alkoxylated branched alcohol as stand-alone product—are diluted with water in such a way that approximately 0.01 to 10, preferably approximately 0.05 to 5 and in particular 0.1 to 1 kg of at least one alkoxylate according to the invention are applied per ha.

In the context of the present description, quantities generally refer to the total weight of a composition, unless otherwise specified. In accordance with the invention, the term “essentially” generally relates to a percentage ratio of at least 80% or preferably at least 90% and in particular at least 95%.

The invention is illustrated in greater detail by the examples which follow:

### PREPARATION EXAMPLES

### Reference Examples 1 to 6

Preparation of the Alkoxylates (a) to (f)

The weight-average molecular weights of the alkoxylates (a) to (f) were determined by gel permeation chromatography, as follows:

| Apparatus: | degasser | |
|---|---|---|
| | pump (very precise pump capacity must | |
| | be ensured) | |
| | RI detector RI 2000 (Duratec) | |
| | UV detector L 4000 (Merck) | |
| | autosampler | |
| | column thermostat | |
| | printer | |
| | PC - monitor/keyboard | |
| | software: | PSS WinGPC 6.20 |
| | columns: | precolumn SDV 5μ - 8 × 50 mm |
| | | SDV 5 10 000 Å |
| | | SDV 5μ 1000 Å |
| | | SDV 5μ 100 Å |

| | |
|---|---|
| Calibration substances: | DIN polystyrene from PSS, Mainz |
| Standard: | toluene |
| Eluent: | tetrahydrofuran, chromatography grade |
| Flow rate: | 1 ml/min |
| Sample preparation: | approx. 25 mg sample + |
| | 1 ml solvent (250 ml THF - 1.5 g toluene) |
| | The toluene is mixed with the THF beforehand, |
| | in order to obtain reproducible results. |

Deviations of up to 10% are possible, despite calibration.

Protocol for determining the ISO index of an alcohol mixture of secondary and/or primary alcohols via ¹H-NMR:

Approximately 20 mg alcohol mixture are dissolved in 0.4 ml CDCl₃ and a small amount of TMS is added for frequency referencing. Subsequently, the solution is supplemented with 0.2 ml TAl, loaded into a 5 mm NMR tube and measured in the NMR spectrometer.

Measuring conditions:
Frequency of spectrometer: 400 MHz
Delay of relaxation: 10 s
Angle of pulse: 30°
Recorded data points: 64 K
Number of scans: 64
Transformed data points: 64 K
Exponential multiplication: 0.2 Hz

After Fourier transformation, automated phase and baseline correction a manual integration of the ranges from 5.4 to 3.7 ppm (all secondary and primary TAl esterified alcohols, respectively) and from 2.4 to 0.4 ppm (all methyl, methylene and methine protons) follows. Thereby the zero-order integral phases are chosen so that beginning and end of the integral curves run substantially horizontally. The signals <1 ppm are assigned to the methyl groups.

### Reference Example 1

### Stearyl Alcohol+10 Styrene Oxide+20 EO (a)

An autoclave was charged with 108 g of stearyl alcohol (corresponding to 0.4 mol) together with 3.76 g of 50% strength potassium hydroxide (alkoxylation catalyst; corresponding to 0.2% by weight based on the total batch). The mixture was dehydrated in the reactor.

First, a mixture of 480.6 g of styrene oxide (corresponding to 4.0 mol) and then 352.4 g of ethylene oxide (corresponding to 8.0 mol) were gassed in continuously at 130° C.

To complete the reaction, stirring was continued for 30 minutes while cooling to 80° C.

This gave 945 g of the alcohol alkoxylate (a) with a weight-average molecular weight of approximately 2061 g/mol (determination by GPC).

### Reference Example 2

### Stearyl Alcohol+10 Styrene Oxide+10.5 EO (b)

An autoclave was charged with 135 g of stearyl alcohol (corresponding to 0.5 mol) together with 3.87 g of 50% strength potassium hydroxide (alkoxylation catalyst; corresponding to 0.2% by weight based on the total batch). The mixture was dehydrated in the reactor.

First, 600.7 g of styrene oxide (corresponding to 5.0 mol) and then 231.3 g of ethylene oxide (corresponding to 5.25 mol) were gassed in continuously at 130° C.

To complete the reaction, stirring was continued for 30 minutes while cooling to 80° C.

This gave 940 g of the alcohol alkoxylate (b) with a weight-average molecular weight of approximately 1584 g/mol (determination by GPC).

### Reference Example 3

### Stearyl Alcohol+20 EO+1 Styrene Oxide (c)

An autoclave was charged with 189 g of stearyl alcohol (corresponding to 0.7 mol) together with 3.56 g of 50% strength potassium hydroxide (alkoxylation catalyst; corresponding to 0.2% by weight based on the total batch). The mixture was dehydrated in the reactor.

First, 616.7 g of ethylene oxide (corresponding to 14 mol) and then 84.1 g of styrene oxide (corresponding to 0.7 mol) were gassed in continuously at 130° C.

To complete the reaction, stirring was continued for 30 minutes while cooling to 80° C.

This gave 889 g of the alcohol alkoxylate (c) with a weight-average molecular weight of approximately 1814 g/mol (determination by GPC).

### Reference Example 4

### 2-Propylheptanol+1 Styrene Oxide+8 EO (d)

An autoclave was charged with 55.3 g of 2-propylheptanol (corresponding to 0.35 mol) together with 0.88 g of 50% strength potassium hydroxide (alkoxylation catalyst; corresponding to 0.2% by weight based on the total batch). The mixture was dehydrated in the reactor.

First, 42 g of styrene oxide (corresponding to 0.35 mol) and then 123.2 g of ethylene oxide (corresponding to 2.8 mol) were gassed in continuously at 130° C.

To complete the reaction, stirring was continued for 30 minutes while cooling to 80° C.

This gave 215 g of the alcohol alkoxylate (d) with a weight-average molecular weight of approximately 1079 g/mol (determination by GPC).

### Reference Example 5

### 2-Propylheptanol+10 EO+1 Styrene Oxide (e)

An autoclave was charged with 47.4 g of 2-propylheptanol (corresponding to 0.3 mol) together with 0.89 g of 50% strength potassium hydroxide (alkoxylation catalyst; corresponding to 0.2% by weight based on the total batch). The mixture was dehydrated in the reactor.

First, 132 g of ethylene oxide (corresponding to 3 mol) and then 36 g of styrene oxide (corresponding to 0.3 mol) were gassed in continuously at 130° C.

To complete the reaction, stirring was continued for 30 minutes while cooling to 80° C.

This gave 213 g of the alcohol alkoxylate (e) with a weight-average molecular weight of approximately 1112 g/mol (determination by GPC).

### Reference Example 6

### 2-propylheptanol+1 styrene oxide+12 EO (f)

An autoclave was charged with 39.5 g of 2-propylheptanol (corresponding to 0.25 mol) together with 0.8 g of 50% strength potassium hydroxide (alkoxylation catalyst; corresponding to 0.2% by weight based on the total batch). The mixture was dehydrated in the reactor.

First, 30 g of styrene oxide (corresponding to 0.25 mol) and then 132 g of ethylene oxide (corresponding to 3 mol) were gassed in continuously at 130° C.

To complete the reaction, stirring was continued for 30 minutes while cooling to 80° C.

This gave 199 g of the alcohol alkoxylate (f) with a weight-average molecular weight of approximately 1270 g/mol (determination by GPC).

### Reference Example 7

### 2-propylheptanol+1 styrene oxide+10 EO (g)

An autoclave was charged with 158 g of 2-propylheptanol (corresponding to 1 mol) together with 2.9 g of 50% strength potassium hydroxide (alkoxylation catalyst; corresponding to 0.2% by weight based on the total batch). The mixture was dehydrated in the reactor.

First, 120 g of styrene oxide (corresponding to 1 mol) and then 440 g of ethylene oxide (corresponding to 10 mol) were gassed in continuously at 130° C.

To complete the reaction, stirring was continued for 30 minutes while cooling to 80° C.

This gave 724 g of the alcohol alkoxylate (g) with a weight-average molecular weight of approximately 1259 g/mol (determination by GPC).

### Reference Example 8

### Butyldipropylene Glycol+1 Styrene Oxide+10.5 EO (h)

An autoclave was charged with 190 g of butyldipropylene glycol (corresponding to 1 mol) together with 3.68 g potassium tert-butylate (alkoxylation catalyst; corresponding to 0.5% by weight based on the total batch). The mixture was dehydrated in the reactor.

First, 120 g of styrene oxide (corresponding to 1 mol) and then 462 g of ethylene oxide (corresponding to 10.5 mol) were gassed in continuously at 130° C.

To complete the reaction, stirring was continued for 30 minutes while cooling to 80° C.

This gave 758 g of the alcohol alkoxylate (h) with a weight-average molecular weight of approximately 1097 g/mol (determination by GPC).

### Example 1

### Activity

### Preparation of the Formulations

125 g/l epoxiconazole were ground together with in each case 20 g/l dispersant (Atlas G 5000¹, Synperonic A¹) and 50 g/l propylene glycol in aqueous medium in a stirred-ball mill (dyno-mill) until a particle size of 80%<2 μm was reached. The mixture was treated with 3 g/l antifoam, for example Rhodorsil 426², 3 g/l thickener, for example Rhodopol 23², and a biocide, for example Acticide MBS³. Then, the respective adjuvant, in aqueous solution or in a solvent, for example Solvesso⁴, was stirred in, so that the formulation had a final concentration of 62.5 g/l epoxiconazole and 125 g/l adjuvant.

### ¹Uniquema/Croda

### ²Rhodia

### ³Thor Chemie Exxon-Mobil

### ⁴Exxon-Mobil

Biotest (curative control of leaf rust of wheat):

Leaves of wheat seedlings of the species “Kanzler” which had been grown in pots were dusted, in the two-leaf stage, with spores of leaf rust of wheat “Puccinia recondita” and incubated for 2 days in the greenhouse at high atmospheric humidity. In fully automated spray cabins, the plants were then sprayed with the formulations which comprised the active ingredients and adjuvants specified hereinbelow. The spray mixtures comprised 50, 25 or 12.5 ppm epoxiconazole and 100, 50 or 25 ppm adjuvant. The ratio active ingredient to adjuvant was, accordingly, 1:2. After the spray coatings had dried, the plants were returned to the greenhouse and grown at temperatures between 20 and 24° C. and a relative atmospheric humidity of 60 to 90%. After 10 days, the extent of the leaf rust disease was determined visually as disease percent of the total leaf area. 3 pots were evaluated for each combination.

### Results:

| | | Disease after 10 days | | |
|---|---|---|---|---|
| | | in percent at | | |
| Variant | Adjuvant | 50 ppm | 25 ppm | 12.5 ppm |
| untreated | | 80 | 80 | 80 |
| without adjuvant | | 23 | 37 | 57 |
| reference example 1 | 1-stearyl alcohol + 10.0 SO + 20.0 EO | 0 | 0 | 25 |
| reference example 2 | 1-stearyl alcohol + 10.0 SO + 10.5 EO | 0 | 8 | 25 |
| reference example 3 | 1-stearyl alcohol + 20 EO + 1 SO | 0 | 10 | 37 |
| reference example 4 | 2-propylheptanol + 1 styrene oxide + 8 EO | 2 | 11 | 28 |
| reference example 5 | 2-propylheptanol + 10 EO + 1 styrene oxide | 0 | 5 | 22 |
| reference example 6 | 2-propylheptanol + 1 styrene oxide + 12 EO | 0 | 6 | 34 |
| reference example 7 | 2-propylheptanol + 1 SO + 10 EO | 1 | 8 | 33 |
| reference example 8 | butyldipropylene glycol + 1.0 SO + 10.5 EO | 4 | 11 | 35 |

1.-41. (canceled)

42. A composition comprising
(a) at least one active ingredient for treating plants; and
(b) at least one alkoxylated alcohol of the formula (I)
R—O—(CₚH₂ₚO)_{q}-[(CₙH₂ₙO)-(PhC₂H₃O)_{y}—(CₘH₂ₘO)_{z}]_{co}-Z (I)
in which
R represents an aliphatic or aromatic radical having 1 to 30 carbon atoms;
p represents 2 or 3;
q represents 0, 1, 2 or 3;
n, m independently of one another represent an integer from 2 to 16;
x represents a value of from 0 to 100;
y represents a value of from 0.5 to 100;
z represents a value of from 0 to 100;
x+y+z corresponds to a value of from 2 to 100, and
Z represents hydrogen or an end cap,
where at least one of x or z is greater than 0 and the molecular weight of the alkoxylated alcohol is less than 5000 g/mol.

43. The composition according to claim 42, wherein the alkoxylated alcohol is an alkoxylated alcohol of the formula (IIa)
R—O—(CₚH₂ₚO)_{q}-(PhC₂H₃O)_{y}—(CₘH₂ₘO)_{z}—Z (IIa),
wherein R, p, q, m, y, z, Z are as defined in claim 42 and z is greater than zero.

44. The composition according to claim 42, wherein the alkoxylated alcohol is an alkoxylated alcohol of the formula (IIb)
R—O—(CₚH₂ₚO)_{q}—(CₙH₂ₙO)ₓ-(PhC₂H₃O)_{y}-Z (IIb),
where R, p, q, n, x, y, Z are as defined in claim 42 and x is greater than zero.

45. The composition according to claim 42, wherein n and m independently of one another represent 2, 3, 4, 5 or 6.

46. The composition according to claim 45, wherein n=2.

47. The composition according to claim 45, wherein m=2.

48. The composition according to claim 42, wherein the total of x, y and z, of y and z, or of x and y corresponds to a value of from 2 to 100, 4 to 80, 5 to 60, 6, 7 or 8 to 40, or 10 to 30.

49. The composition according to claim 42, wherein the value of z, the value of x or the total of x and z is greater than the value of y.

50. The composition according to claim 49, wherein the ratio of z to y, x to y or (x+z) to y is at least 1.1:1, at least 1.5:1, at least 2:1, at least 5:1, or at least 10:1.

51. The composition according to claim 42, wherein x, z, or y+z corresponds to a value of from 1 to 50, 3 to 30, or 5 to 20.

52. The composition according to claim 42, wherein y corresponds to a value of from 0.5 to 30, 0.9 to 20, or 1 to 15.

53. The composition according to claim 42, wherein R is selected from the
group consisting of 2-ethylhexanol, 2-propylheptyl, isodecyl and isotridecyl.

54. The composition according to claim 42, wherein R is selected from the group consisting of butyl and stearyl.

55. The composition according to claim 42, wherein q is zero.

56. The composition according to claim 42, wherein q is 1, 2 or 3.

57. The composition according to claim 42, wherein p=3.

58. The composition according to claim 42, wherein Z is hydrogen.

59. The composition according to claim 42, wherein component (b) amounts to more than 5% by weight of the total weight of the composition.

60. The composition according to claim 42, wherein the active ingredient is selected from the group consisting of boscalid, carboxin, metalaxyl, oxadixyl, 5-chloro-7-(4-methylpiperidin-1-yl)-6-(2,4,6-trifluorophenyl)-[1,2,4]triazole[1,5-a]-pyrimidine, azoxystrobin, pyraclostrobin, dimoxystrobin, trifloxystrobin, fluoxystrobin, picoxystrobin, orysastrobin, epoxiconazole, metconazole, tebuconazole, flusilazole, fluquinconazole, triticonazole, propiconazole, penconazole, cyproconazole and prothioconazole.

61. A method of controlling undesired growth of a plant comprising treating the plant with a composition comprising an alkoxylated alcohol of the formula (I)
R—O—(CₚH₂ₚO)_{q}[—(CₙH₂ₙO)x-(PhC₂H₃O)_{y}—(CₘH₂ₘO)_{z}]_{co}-Z (I)
in which
R represents an aliphatic or aromatic radical having 1 to 30 carbon atoms;
p represents 2 or 3;
q represents 0, 1, 2 or 3;
n, m independently of one another represent an integer from 2 to 16;
x represents a value of from 0 to 100;
y represents a value of from 0.5 to 100;
z represents a value of from 0 to 100;
x+y+z corresponds to a value of from 2 to 100, and
Z represents hydrogen or an end cap,
where at least one of x or z is greater than 0.
